(19) United States
(12) Patent Application Publication
(10) Pub. No.: US 2024/0281693 A1
(43) Pub. Date: Aug. 22, 2024

(54) OPERATOR IMPLEMENTATIONS FOR QUANTUM COMPUTATION

(71) Applicant: THE GOVERNING COUNCIL OF THE UNIVERSITY OF TORONTO, Toronto (CA)

(72) Inventors: Artur Izmaylov, Toronto (CA); Abhinav Anand, Toronto (CA); Jakob Kottmann, Toronto (CA); Alan Aspuru-Guzik, Toronto (CA); Robert Lang, Toronto (CA); Tzu-ching Yen, Taichung (TW)

(21) Appl. No.: 18/034,444

(22) PCT Filed: Oct. 19, 2021
(86) PCT No.: PCT/CA2021/051467

§ 371 Date: Apr. 28, 2023

Related U.S. Application Data
(60) Provisional application No. 63/106,423, filed on Oct. 28, 2020.
(60) Provisional application No. 63/222,546, filed on Jul. 16, 2021.

(51) Int. Cl. G06N 10/60; G06F 17/14; G06N 10/20; G06N 10/40

(52) U.S. Cl. CPC G06N 10/60; G06F 17/14; G06N 10/20; G06N 10/40

(57) ABSTRACT

A computer-implemented method and system for implementing a n-fold fermionic excitation generator using linear combination of directly differentiable operators on a quantum computer. Computer-readable data is generated and stored which when executed on the quantum computer, causes a quantum circuit of the quantum computer to execute repeatedly to perform a sequence of operations that implements the unitary (I) generated by a fermionic n-fold excitation operator G. The Gradient with respect to the angle Θ of arbitrary expectation values involving the unitary operation can, in the general case, be evaluated by four expectation values obtained from replacing the corresponding unitary with fermionic shift operations (II). Fermionic shift operations can be constructed through the original unitary and unitary operations generated by the nullspace projector P₀ of the fermionic excitation generator. Other operators and generators are disclosed.

### FIELD OF THE INVENTION

The present disclosure relates generally to quantum computer frameworks for optimizing problems and frameworks for computing molecular properties. In particular, the disclosure relates to the generation of unitary operators representing gradients in general variational quantum optimization algorithms.

### BACKGROUND OF THE INVENTION

Fermion was first coined by Paul Dirac after physicist Enrico Fermi to describe a category of elementary particles which make up atoms. Fermions are thought to be the building blocks of matter.

Computing properties of molecules, materials, and other fermionic systems are of academic interest, particularly in science and technology fields. It is possible to calculate and optimize parametrized expectation values where fermionic systems can be mapped to corresponding qubits through several encodings when given access to a universal quantum computer. It is unfeasible for standard fermionic operators to evaluate analytical gradients directly within those encodings due to large pre-factors that grow exponentially with the fermionic excitation rank.

Accordingly, there remains a need for improvements in the art.

### SUMMARY OF THE INVENTION

According to some embodiments, directly differentiable operators are generated to generate/approximate an eigenenergy value of a quantum chemical Hamiltonian.

According to some embodiments, operators are generated for variational quantum optimization, where the optimized function can be either eigen-energy or expectation value of any other operator. According to some embodiments, this is implemented within a variational quantum eigensolver framework, where optimized quantities are parameters of unitary operators. The parametrization is exp(itG), where t is the parameter and G is a generator of the unitary operation.

According to some embodiments, exact fermionic excitation generators can be written as a linear combination of two directly differentiable operators that generate two directly differentiable unitary operations. Multiple of those unitary operations can be parametrized and executed sequentially to prepare a quantum state whose expectation value with respect to a quantum chemical Hamiltonian or other observables can be minimized or enter more general objective functions. The optimized parametrization can prepare an approximation to an eigenstate of the quantum chemical Hamiltonian. According to some embodiments, the electron spin (S2) is conserved using operators that are linear combinations of operators described herein.

According to an embodiment, a framework for expressing fermionic operators using two different strategies is provided that enables a feasible method for evaluating gradients with a constant cost factor of four or two, independent of the excitation rank with respect to the original expectation value cost. This framework can allow for gradient-based optimization by automatic differentiation to be feasible, while keeping the original generators at a minimal cost of additional gates in the circuit. This framework can allow for the use of an arbitrary combination of fixed and adaptively growing parts of the quantum circuit to estimate the ground-state as well as excited state energies.

According to an embodiment of the invention, there is provided a decomposition of the unitary for the exact fermionic excitation operators,

$${e}^{- i \frac{θ}{2} G}$$

as a linear combination of two directly differentiable operators

$${e}^{- i \frac{θ}{2} P +} and {e}^{- i \frac{θ}{2} {P}_{-}} ,$$

where G is the generator for the fermionic excitation, P₊ and P₋ are the projectors onto the eigenvalues of G multiplied by their respective eigenvalues ±1. This decomposition can reduce the cost of evaluating gradients to a constant factor of four with respect to the original expectation value cost.

According to an embodiment, there is implemented various decompositions for unitary operators as described herein. One or more of these decompositions can provide more efficient ways to treat operators beyond fermionic.

In an embodiment of the invention, there is provided another decomposition of the exact fermionic excitation operators, as a linear combination of two self-inverse operators

$$G = \frac{1}{2} ( {G}_{+} + {G}_{-} ) ,$$

where G is the generator for the fermionic excitation and G_{±}=G±P₀ are modified generators by adding/subtracting the null space projector to the original generator. The analytical form of the unitary generated by the fermionic excitation operators,

$${e}^{- i \frac{θ}{2} G}$$

in this decomposition is also provided,

$${e}^{- i \frac{θ}{2} G} = cos ( \frac{θ}{2} ) 1 - i sin ( \frac{θ}{2} ) G + ( 1 - cos ( \frac{θ}{2} ) ) {P}_{0} ,$$

where P₀ is the null space projector of the respective generator.

According to an embodiment of the invention, there is provided the expression for the unitaries U_{±}^{α}, αϵ{+, −} to calculate the four expectation values for the analytical gradient

$${U}_{\pm }^{α} ( θ ) = {U}_{\pm } ( θ ) {U}_{0}^{α} = {e}^{- i \frac{1}{2} ( θ \pm \frac{π}{2} ) G} {e}^{- α \frac{i}{2} ( \pm \frac{π}{2} ) {P}_{o}} , αϵ \{ + , - \}$$

where G is the generator for the exact fermionic excitation and P₀ is the null space projector. The framework can then lead to a further reduction for the gradient evaluation in the case when only real wavefunctions are involved.

According to an embodiment of the invention, the framework also provides a way of generating/approximating eigenenergies using only modified single directly differentiable operators G_{±}=G±P₀, where G is the generator for the exact fermionic excitation and P₀ is the null space projector. This can allow for calculation of the gradient with a cost factor of 2, with respect to the original expectation value.

According to an embodiment of the invention, the framework does not depend on the other operators in the full unitary that is mapped to the quantum computer which allows for combination of static and adaptive blocks with marginal additional cost in the number of quantum gates, however the cost of screening and optimization can remain unaffected.

According to some embodiments, there is provided a method performed by a classical computer for implementing, on a quantum computer, a n-fold fermionic excitation operator, and calculating analytical gradients with fermionic shift operations, the quantum computer having a plurality of qubits and configurable to implement a universal set of gates; the classical computer including a processor, a non-transitory computer-readable medium, and computer program instructions stored in the non-transitory computer-readable medium, the computer program instructions being executable by the processor to perform the method. The method includes generating and storing, in the non-transitory computer-readable medium, computer-readable data that, when executed on the quantum computer, causes a quantum circuit of the quantum computer to execute repeatedly to perform a sequence of operations that implements the unitary

$${e}^{- i \frac{θ}{2} G} = cos ( \frac{θ}{2} ) 1 - i sin ( \frac{θ}{2} ) G + ( 1 - cos ( \frac{θ}{2} ) ) {P}_{0} ,$$

wherein P₀ is the null space projector onto the eigenvectors of the n-fold excitation operator G_{pq}, wherein G_{pq}=i(Πₙaₚ_{ₙ}^{†}a_{q}_{ₙ}−h.c.), wherein aₚ_{ₙ}^{†} is a creation operator for the n-fold excitation of the orbital pₙ, and wherein a_{q}_{ₙ} is an annihilation operator for the n-fold excitation of the orbital qₙ; and calculating the analytical gradient of an expectation value

$$\frac{\partial {〈 H 〉}_{XU ( θ ) Y}}{\partial θ} = \frac{1}{4} {\sum }_{α ∈ \{ + , - \}} ( {〈 H 〉}_{X {U}_{+}^{α} Y} - {〈 H 〉}_{{XU}_{-}^{α} Y} )$$

by measuring only four expectation values, wherein

$${U}_{\pm }^{α} ( θ ) = {U}_{\pm } ( θ ) {U}_{0}^{α} = {e}^{- i \frac{1}{2} ( θ \pm \frac{π}{2} ) G} {e}^{- α \frac{i}{2} ( \pm \frac{π}{2} ) {P}_{o}}$$

are the fermionic shift gates, and wherein P₀ is the null space projector onto the eigenvectors of the n-fold excitation operator G.

According to some embodiments, there is provided a system including: a classical computer, the classical computer comprising a processor, a non-transitory computer-readable medium, and computer program instructions stored in the non-transitory computer-readable medium; a quantum computer comprising a plurality of qubits; and able to implement a universal set of gates. The computer program instructions, when executed by the processor, perform a method for implementing, on the quantum computer, a n-fold fermionic excitation operator, the method comprising: generating and storing, in the non-transitory computer-readable medium, computer-readable data that, when executed on the quantum computer, causes a quantum circuit of the quantum computer to execute repeatedly to perform a sequence of operations that implements the unitary

$${e}^{- i \frac{θ}{2} G}$$

corresponding to the n-fold excitation operator G_{pq}, wherein G_{pq}=i(Πₙaₚ_{ₙ}^{†}a_{q}_{ₙ}−h.c.), wherein aₚ_{ₙ}^{†} is a creation operator for the n-fold excitation of the orbital pₙ, and a_{q}_{ₙ} is an annihilation operator for the n-fold excitation of the orbital qₙ and calculating the analytical gradient of an expectation value

$$\frac{\partial {〈 H 〉}_{X U ( θ ) Y}}{\partial θ} = \frac{1}{4} {\sum }_{α ∈ \{ + , - \}} ( {〈 H 〉}_{{XU}_{+}^{α} Y} - {〈 H 〉}_{{XU}_{-}^{α} Y} )$$

by measuring only four expectation values, wherein

$${U}_{\pm }^{α} ( θ ) = {U}_{\pm } ( θ ) {U}_{0}^{α} = {e}^{- i \frac{1}{2} ( θ \pm \frac{π}{2} ) G} {e}^{- α \frac{i}{2} ( \pm \frac{π}{2} ) {P}_{o}}$$

are the fermionic shift gates, wherein P₀ is the null space projector onto the eigenvectors of the n-fold excitation operator G.

According to some embodiments, there is provided a computer product with non-transitory computer-readable media storing program instructions, the computer program instructions being executable on a quantum computer to cause a quantum circuit of the quantum computer to execute repeatedly to perform a sequence of operations that implements the unitary corresponding to n-fold excitation generator

$${e}^{- i \frac{θ}{2} G}$$

corresponding to n-fold excitation operator G_{pq}=i(Πₙaₚ_{ₙ}^{†}a_{q}_{ₙ}−h.c.) wherein aₚ_{ₙ}^{†} is a creation operator for the n-fold excitation of the orbital pₙ and a_{q}_{ₙ} is an annihilation operator for the n-fold excitation of the orbital qₙ.

According to some embodiments, there is provided a method performed by a classical computer for implementing, on a quantum computer, an operator, wherein: the quantum computer having a plurality of qubits and configurable to implement a universal set of gates; the classical computer including a processor, a non-transitory computer-readable medium, and computer program instructions stored in the non-transitory computer-readable medium, the computer program instructions being executable by the processor to perform the method. The method comprises: generating and storing, in the non-transitory computer-readable medium, computer-readable data that, when executed on the quantum computer, causes a quantum circuit of the quantum computer to execute repeatedly to perform a sequence of operations that implements a unitary transformation for reducing the evaluation of a gradient to measurement of one or more expectation values.

According to some embodiments, the unitary transformation is implemented by implementing: a polynomial expansion

$${e}^{i θ \hat{G}} = {\sum }_{n = 0}^{L - 1} {a}_{n} ( θ ) {( i \hat{G} )}^{n}$$

of the unitary transformation, where G is the generator of the unitary transformation, θ is the amplitude for the gradient taken, aₙ(θ) are functions for evaluation, and L is the number of distinct eigenvalues present in G.

According to some embodiments, the unitary transformation is implemented by implementing: a generator decomposition to low-eigenvalue operators, where the generator decomposition is

$$\hat{G} = {\sum }_{n = 1}^{K} {d}_{n} {O}_{n} ,$$

where G is the generator, K is the number of terms, dₙ represents coefficients to be determined, and Oₙ represents operators with two or three distinct eigenvalues.

According to some embodiments, there is provided a system as well as a computer product with non-transitory computer-readable media storing program instructions, the computer program instructions being executable on a quantum computer to perform the methods described herein.

Other aspects and features according to the present invention will become apparent to those ordinarily skilled in the art upon review of the following description of embodiments of the invention in conjunction with the accompanying figures.

### BRIEF DESCRIPTION OF THE DRAWINGS

Reference will be made to the accompanying figures to provide exemplary embodiments of the invention, incorporating principles and aspects of the present invention, and in which, according to some embodiments:

FIG. 1 shows a schematic overview over naive approaches for calculating analytical gradients on the qubit level using the shift rule, and the general gradient evaluation schemes on the fermionic level according to function (A7) as well as for real wavefunctions according to function (A9);

FIG. 2 shows a schematic diagram to illustrate the incorporation of automatically differentiable circuits into a generalized adaptive framework;

FIGS. 3A, 3B, and 3C show a framework for algorithms with a combination of static and adaptive blocks and a sequential solver for excited states;

FIGS. 4A and 4B show a set of multiple line graphs denoting the result for the simulation of H4 and BeH2 in the minimal basis STO-3G using generalized Adapt-VQE approaches illustrated in FIG. 2;

FIGS. 5A and 5B show a set of multiple line graphs denoting the result for the screening and optimization for H4 and BeH2 using different combinations of static and adaptive blocks; and

FIG. 6 shows a set of line graphs denoting the results for Hydrogen molecule in minimal basis (STO-3G) with restricted excitation operator.

### DETAILED DESCRIPTION OF THE EMBODIMENTS

The description that follows, and the embodiments described therein, are provided by way of illustration of an example, or examples, of embodiments of the principles of the present invention. These examples are provided for the purposes of explanation, and not of limitation, of those principles, and of the invention. In the description, like parts are marked throughout the specification and the drawings with the same respective reference numerals.

The description relates to quantum computation in general variational quantum optimization algorithms, such as per the design in D1 (Artur F. Izmaylov, Robert A. Lang, and Tzu-Ching Yen. Analytic gradients in variational quantum algorithms: Algebraic extensions of the parameter-shift rule to general unitary transformations) the entirety of which is hereby incorporated by reference.

The description further relates to black box determination of molecular properties on quantum computers through directly automatically differentiable fermionic operators, such as per the design in D2 (J. S. Kottmann, A. Anand, and A. Aspuru-Guzik. A Feasible Approach for Automatically Differentiable Unitary Coupled-Cluster on Quantum Computers) the entirety of which is hereby incorporated by reference.

The present description relates to efficient gradient evaluation techniques using a type of operators appearing not only in fermionic problems but also in general variational quantum optimization algorithms. Operators appearing in the unitary coupled cluster method, as well as more general alternative solutions are presented. Gradients (e.g., first derivatives) are determined for implementation in a quantum computer to solve optimization problems.

Optimization of unitary transformations in Variational Quantum Algorithms (VQA) benefits highly from efficient evaluation of cost function gradients with respect to amplitudes of unitary generators. Embodiments described herein implement several extensions of the parametric-shift-rule to formulating these gradients as linear combinations of expectation values for generators with general eigen-spectrum (i.e., with more than two eigenvalues). Embodiments provided can be exact and not use any auxiliary qubits; instead they can use a generator eigen-spectrum analysis. Two main directions in the parametric-shift-rule extensions are: 1) polynomial expansion of the exponential unitary operator based on a limited number of different eigenvalues in the generator and 2) decomposition of the generator as a linear combination of low eigenvalue operators (e.g., operators with only 2 or 3 eigenvalues). These implementations have a range of scalings for the number of needed expectation values with the number of generator eigenvalues from quadratic (for polynomial expansion) to linear and even log₂ (for generator decompositions). Embodiments described herein implement efficient differentiation schemes for 2-qubit transformations (e.g., match-gates, transmon and fSim gates) and S\hat{ }²-conserving fermionic operators for the variational quantum eigensolver.

VQAs provide a main route to employing noisy intermediate scale quantum hardware without error correction to solve classically difficult optimization problems in quantum chemistry, information compression, machine learning, and number factorization. The mathematical formulation of VQA involves a cost function defined as follows

$$E ( τ ) = 〈 \overline{0} \vert {Û}^{†} ( τ ) \hat{H} Û ( τ ) \vert \overline{0} 〉 , \qquad ( 1 )$$

where H is some hermitian N-qubit operator (e.g., the quantum system Hamiltonian for quantum chemistry applications), U(τ) is a unitary transformation encoded on a quantum computer as a circuit operating on the initial state of N qubits |0̅ [symbol] ≡|0 [symbol] ^{⊗N}.

To avoid deep circuits, E(τ) is optimized with respect to τ components using a hybrid quantum-classical iterative process: 1) every set of τ parameters is implemented on a quantum computer to measure value of E(τ) and 2) results of quantum measurements are passed to a classical computer to suggest a next set of τ parameters.

This hybrid scheme becomes more efficient if a quantum computer can provide gradients of E(τ) with respect to τ components. Usual parametrizations of unitary transformations are organized as products of exponential functions of some hermitian generators {Ĝₖ},

$$Û ( τ ) = {\prod }_{k} exp ( i {τ}_{k} {\hat{G}}_{k} ) . \qquad ( 2 )$$

The choice of efficient generators is generally a challenging problem whose solution often relies on heuristics of a concrete field (e.g., in quantum chemistry there are a large variety of techniques). Due to general non-commutativity of generators, τₖ gradients can be written as

$$\frac{\partial E}{\partial {τ}_{k}} = \frac{\partial }{\partial {τ}_{k}} 〈 \overline{0} \vert {Û}_{1}^{†} {e}^{- {iτ}_{k} {\hat{G}}_{k}} {Û}_{2}^{†} \hat{H} {Û}_{2} {e}^{{iτ}_{k} {\hat{G}}_{k}} {Û}_{1} \vert \overline{0} 〉 = i 〈 \overline{0} \vert {Û}_{1}^{†} {e}^{- {iτ}_{k} {\hat{G}}_{k}} [ {Û}_{2}^{†} \hat{H} {Û}_{2} , {\hat{G}}_{k} ] {e}^{{iτ}_{k} {\hat{G}}_{k}} {Û}_{1} \vert \overline{0} 〉 , \qquad ( 3 )$$

where U\hat{ }_{1,2} are U\hat{ } parts on the left and right sides of the G\hat{ }ₖ exponent. Evaluating the gradient as the expectation value in Eq. (3) requires extra efforts to accommodate for non-symmetric distribution of unitary transformations around H\hat{ } (considering the simplest case when G\hat{ }ₖ is also unitary). This treatment requires introducing an auxiliary qubit and controlled unitaries in the circuit, which enhance depth of the circuit.¹⁵

In the case when G\hat{ }ₖ has only two eigenvalues symmetrically distributed, {±λ}, the so-called parametric-shift-rule (PSR) is applicable to Eq. (3)

$$\frac{\partial E}{\partial {τ}_{k}} = λ ( 〈 \overline{0} \vert {Û}_{1}^{†} {e}^{- i ( {τ}_{k} + s ) {\hat{G}}_{k}} {Û}_{2}^{†} \hat{H} {Û}_{2} {e}^{i ( {τ}_{k} + s ) {\hat{G}}_{k}} {Û}_{1} \vert \overline{0} 〉 - i 〈 \overline{0} \vert {Û}_{1}^{†} {e}^{- i ( {τ}_{k} - s ) {\hat{G}}_{k}} {Û}_{2}^{†} \hat{H} {Û}_{2} {e}^{i ( {τ}_{k} - s ) {\hat{G}}_{k}} {Û}_{1} \vert \overline{0} 〉 , \qquad ( 4 )$$

where s=π/(4λ). This approach allows one to evaluate the expectation values in Eq. (4) using the same circuit as for E(τ) with only minor modifications of τ parameters. Embodiments described herein implement such determination of these expectation values.

According to an embodiment, the PSR is extended to a general unitary transformation containing generators with more than 2 eigenvalues. The algebraic form of these extensions is set to be a linear combination of expectation values of Eq. (4). Such extensions are motivated by hardware implementations (e.g., 2-qubit gates, generally have 4 eigenvalues) and specific problems (e.g., new generators for solving quantum chemistry problems). Also, these extensions will allow a quantum computer to reduce the number of optimized parameters if more complex generators can be considered.

Generators with more than two eigenvalues can naturally be decomposed to generators with two eigenvalues for which the PSR can be applied individually. Such decompositions can be considered for some standard 2-qubit gates. There has been no attempt to systematically address the minimization of the number of terms in such decompositions or their extensions beyond 2-qubit operators.

A naive application of a decomposition scheme to generators of the unitary coupled cluster (UCC) approach can lead to exponential growth of the number of terms (Pauli products) with two eigenvalues. Using a specifically tailored decomposition of UCC generators (fermionic-shift rule), the exponential growth of expectation values needed for gradient evaluation in the Pauli product decomposition of UCC generators can be addressed.

Embodiments described herein implement a system, device, and method for performing generator decomposition systematically and for avoiding cases of exponential increase of terms in such decompositions. Examples provided include three generalizations of the PSR based on somewhat different algebraic ideas whose main unifying theme is consideration of the generator eigen-spectrum. The first example implements the exponential function of the generator with K eigenvalues as a K−1 degree polynomial. This enables extension of the PSR by using a larger number of expectation values in a linear combination to cancel all higher powers of the generator. The second example decomposes the generator into a sum of commuting operators with a fewer number of unique eigenvalues. The third example implements a decomposition over non-commutative operators with a low number of eigenvalues. Embodiments described herein implement any one or more of the following mathematical expressions for improvement in the functioning of quantum computation.

According to some embodiments, there is provided two implementations for reducing the evaluation of gradients to measurement of expectation values: 1) polynomial expansion of a unitary transformation; and 2) generator decompositions to low-eigenvalue operators. The polynomial expansion can be expressed as

$${e}^{ιθ \hat{G}} = {\sum }_{n = 0}^{L - 1} {a}_{n} ( θ ) {( i \hat{G} )}^{n} , \qquad ( 5 )$$

where G is the generator of the unitary transformation, θ is the amplitude with respect to which the gradient is taken, aₙ(θ) are functions that are evaluated by the proposed method, and L is the number of distinct eigenvalues present in G.

There are multiple generator decompositions proposed herein. These can be expressed in the form

$$\hat{G} = {\sum }_{n = 1}^{K} {d}_{n} {\hat{O}}_{n} ,$$

where G is the generator, K is the number of terms, dₙ's are coefficients to be determined, and Oₙ's are operators with 2 or 3 distinct eigenvalues. Two decompositions that are described herein are based on the Catan sub-algebras (CSA): 1) commutative CSA decomposition:

$$\hat{G} = {\hat{V}}^{†} ( {\sum }_{n = 1}^{K} {c}_{n} {\hat{Z}}_{n} ) \hat{V} ,$$

where G is the generator, V is a unitary transformation, cₙ are coefficients, Zₙ are CSA elements, and K is the number of terms; and 2) non-commutative CSA decomposition:

$$\text{?}$$

$$\text{?} \text{indicates text missing or illegible when filed}$$

where G is the generator, Vₙ are unitary transformations, cₙ are coefficients, Zₙ are CSA elements, and K′ is the number of terms. According to some embodiments, these decompositions provide formulations that reduce the gradient expressions to a linear combinations of expectation values that can be measured on a quantum computer.

In some embodiments, two methods, polynomial expansion and CSA decompositions, are described herein that lead to more optimal evaluation of gradients using measurements of a fewer number of expectation values on a quantum computer.

### Polynomial Expansion

According to an embodiment, energy partial derivatives (Eq. (3)) can be rewritten as

$$\frac{\partial E}{\partial τ} = i 〈 {e}^{- i τ \hat{G}} {\hat{H}}_{2} \hat{G} {e}^{i τ \hat{G}} 〉 - i 〈 \hat{G} {e}^{- i τ \hat{G}} {\hat{H}}_{2} {e}^{i τ \hat{G}} 〉 ,$$

where k subscript has been removed for simplicity and a short notation is introduced:

$$〈 … 〉 = 〈 \overline{0} \vert {Û}_{1}^{†} … {\hat{U}}_{1} \vert \overline{0} 〉 , {\hat{H}}_{2} = {\hat{U}}_{2}^{†} \hat{H} {\hat{U}}_{2} .$$

Asymmetry of operators' placement around H\hat{ } and potential non-unitarity of G\hat{ } makes the obtained expectation values more challenging to measure. However, this difference can be rewritten as a linear combination of terms measurable on a quantum computer without any modifications of the E(τ) measurement scheme

$$\frac{\partial E}{\partial τ} = {\sum }_{n} {C}_{n} 〈 {e}^{- i ( τ + {0}_{n} ) \hat{G}} {\hat{H}}_{2} {e}^{i ( τ + {0}_{n} ) \hat{G}} 〉 , \qquad ( 5 )$$

where θₙ and Cₙ are coefficients to be defined. The key quantity that defines θₙ and Cₙ is the number of different eigenvalues in G\hat{ }, which will be denoted as L. L defines a finite polynomial expression for the exponential operator_{L-1}

$${e}^{i θ \hat{G}} = {\sum }_{n = 0}^{L - 1} {a}_{n} ( θ ) {( i \hat{G} )}^{n} , \qquad ( 6 )$$

where aₙ(θ)'s are constants obtained by solving a linear system of equations, and Cₙ's are evaluated from another system of linear equations using aₙ(θ)'s with fixed θₙ's. To illustrate the process in the simplest case of L=2, where G\hat{ }'s eigenvalues are ±1, hence G\hat{ }²=1 and

$${e}^{i θ \hat{G}} = {a}_{0} ( θ ) \hat{1} + {a}_{1} ( θ ) ( i \hat{G} ) , \qquad ( 7 )$$

Here, a₀(θ)=cos(θ) and a₁(θ)=sin(θ).

To obtain the energy derivative only two terms in Eq. (5) can be used

$$\frac{\partial E}{\partial τ} = \frac{1}{sin ( 2 θ )} [ 〈 {e}^{- i ( τ + θ ) \hat{G}} {\hat{H}}_{2} {e}^{i ( τ + θ ) \hat{G}} 〉 - 〈 {e}^{- i ( τ - θ ) \hat{G}} {\hat{H}}_{2} {e}^{i ( τ - θ ) \hat{G}} 〉 ] . \qquad ( 8 )$$

For example, G\hat{ } satisfying the described conditions can be any tensor product of Pauli operators for different qubits. For L=3 with symmetric spectrum {0,±1}, 4 expectation values are enough to obtain the analytic gradient. It can be shown that all fermionic operators

$$\hat{G} = {\hat{a}}_{p}^{†} … {\hat{a}}_{q}^{†} {\hat{a}}_{r} … {\hat{a}}_{s} - {\hat{a}}_{s}^{†} … {\hat{a}}_{r}^{†} \breve{{\hat{a}}_{q}} … {\hat{a}}_{p}$$

used in the UCC method have this spectrum. The gradient expressions requiring 4 expectation values for such operators can be determined and can be reduced to only 2 expectation values for real unitary transformations acting on real wavefunctions.

The polynomial expansion for general G\hat{ } with L eigenvalues will produce the gradient expression with the number of expectation values that scales as ˜L². If there are some relations between different eigenvalues, they can be used to reduce the number of expectation values by exploiting freedom in the choice of θₙ and Cₙ parameters.

### Generator Decompositions

According to an embodiment, to address the ˜L² scaling of the number of expectation values in the polynomial expansion approach, instead of Eq. (5) following alternative can be used

$$\frac{\partial E}{\partial τ} = {\sum }_{n} {C}_{n} 〈 {e}^{- i {θ}_{n} {\hat{O}}_{n}} {e}^{- i τ \hat{G}} {\hat{H}}_{2} {e}^{i τ \hat{G}} {e}^{i {θ}_{n} {\hat{O}}_{n}} 〉 \qquad ( 9 )$$

where new operators {O\hat{ }ₙ} are implemented. One useful class of O\hat{ }ₙ's are those that have few eigenvalues (2 or 3) and sum to G\hat{ }

$$\hat{G} = {\sum }_{n = 1}^{K} {d}_{n} {\hat{O}}_{n} , \qquad ( 10 )$$

where dₙ are real coefficients.

Involutory example: According to an embodiment, to illustrate how {O\hat{ }ₙ} decomposition can be used in the gradient evaluation, assume that O\hat{ }ₙs have only two eigenvalues ±1. To define Cₙ and θₙ consider the following pairs

$$〈 {e}^{- i {θ}_{n} {\hat{O}}_{n}} {e}^{- i τ \hat{G}} {\hat{H}}_{2} {e}^{i τ \hat{G}} {e}^{i {θ}_{n} {\hat{O}}_{n}} 〉 - 〈 {e}^{i {θ}_{n} {\hat{O}}_{n}} {e}^{- i τ \hat{G}} {\hat{H}}_{2} \times {e}^{i τ \hat{G}} {e}^{- i {θ}_{n} {\hat{O}}_{n}} 〉 = i sin ( 2 {θ}_{n} ) [ 〈 {e}^{- i τ \hat{G}} {\hat{H}}_{2} {e}^{i τ \hat{G}} {\hat{O}}_{n} 〉 - 〈 {\hat{O}}_{n} {e}^{- i τ \hat{G}} {\hat{H}}_{2} {e}^{i τ \hat{G}} 〉 ] . \qquad ( 11 )$$

The involutory property of {O\hat{ }ₙ} can be used to convert their exponents according to Eq. (7). This consideration shows that to obtain the energy derivative via expansion in Eq. (9) ±θₙ pairs with coefficient C_{±n}=dₙ/sin(±2θₙ) can be selected. The number of the expectation values in Eq. (9) is 2K. K depends not only on the number of G\hat{ } eigenvalues but also on their distribution and degeneracies (or multiplicities). The best case scenario where K=log₂(L) can be formulated—here adding KO\hat{ }ₙ operators produces G\hat{ } whose spectrum has 2^{K} eigenvalues {λⱼ}

$${λ}_{j} = {\sum }_{n = 1}^{K} {d}_{n} {b}_{nj} , {b}_{nj} = \{ \pm 1 \} . \qquad ( 12 )$$

Starting with some G\hat{ }, it is not necessary that its eigenvalues will be encoded so efficiently with involutory operators O\hat{ }ₙ's, yet this best case scenario shows an example implementation using the decomposition approach.

Efficient generator decompositions: According to an embodiment, O\hat{ }ₙ operators optimal for the generator decomposition can depend on the spectrum of G\hat{ }. G\hat{ } can be written in terms of a few qubit or fermionic operators. The number of involved qubits or fermionic spin-orbitals may not exceed the limit when the dimensionality of a faithful representation for involved operators becomes too large to do matrix algebra on a classical computer.

According to an embodiment, the basis for representing G\hat{ } as matrix G is that qubit or fermionic operators expressing G\hat{ } can be considered as basis elements of a Lie algebra. Using a faithful representation of this Lie algebra one can work with corresponding matrices instead of operators. G can be diagonalized G=V^{†}DV to determine choice of optimal O\hat{ }ₙs. According to an embodiment, to minimize the number of O\hat{ }ₙ operators, same can be built from decomposition D=PₙDₙ, where Dₙ are diagonal matrices with a few (2-3) different eigenvalues. Then, O\hat{ }ₙ is obtained via the inverse representation map of Oₙ=V^{†}DₙV. Even the decomposition of the diagonal matrix D is not straightforward to optimize in general case.

A simple example illustrating various possibilities implemented according to an embodiment is

$$\begin{matrix}( \begin{matrix}3 & 0 & 0 & 0 \\ 0 & - 3 & 0 & 0 \\ 0 & 0 & - 1 & 0 \\ 0 & 0 & 0 & 1\end{matrix} ) & = ( \begin{matrix}3 & 0 & 0 & 0 \\ 0 & - 3 & 0 & 0 \\ 0 & 0 & 0 & 0 \\ 0 & 0 & 0 & 0\end{matrix} ) + ( \begin{matrix}0 & 0 & 0 & 0 \\ 0 & 0 & 0 & 0 \\ 0 & 0 & - 1 & 0 \\ 0 & 0 & 0 & 1\end{matrix} ) \\ & = ( \begin{matrix}2 & 0 & 0 & 0 \\ 0 & - 2 & 0 & 0 \\ 0 & 0 & - 2 & 0 \\ 0 & 0 & 0 & 2\end{matrix} ) + ( \begin{matrix}1 & 0 & 0 & 0 \\ 0 & - 1 & 0 & 0 \\ 0 & 0 & - 1 & 0 \\ 0 & 0 & 0 & 1\end{matrix} ) \\ & = 3 ( {P}_{1} - {P}_{2} ) + ( {P}_{4} - {P}_{3} )\end{matrix} , \qquad ( 13 )$$

where Pⱼ is a 4 by 4 matrix with 1 on (j,j)^{th} element and zeroes everywhere else. In this example, the most optimal choice is the second expansion, 2 operators with 2 symmetric eigenvalues each. This example shows that even though the eigen-subspace projector expansion (last in Eq. (13)) is the most straightforward, it is not necessarily the most optimal.

According to an embodiment, example implementations for generating the most optimal solution for the G\hat{ } decomposition problem are presented. Such examples can provide shorter expansions than those from the eigensubspace projector expansion, and the latter can be used as a conservative option.

Commutative Cartan sub-algebra decomposition: According to an embodiment, the implementation uses a Cartan subalgebra (CSA) decomposition for G\hat{ }. This decomposition can be done for an element of any compact Lie algebra. As an example, this can be used for G\hat{ } realized as an element of the N-qubit operator algebra, su(2^{N}),

$$\hat{G} = {\sum }_{n} {C}_{n} {\hat{P}}_{n} , {\hat{P}}_{n} = {\prod }_{j = 1}^{N} {\hat{σ}}_{j} , \qquad ( 14 )$$

where Cₙ are coefficients, and \hat{σ}ⱼ={\hat{x}ⱼ, ŷⱼ, \hat{z}ⱼ, [symbol] ⱼ} is one of the Pauli operator or identity for the j^{th} qubit. su(2^{N}) contains 4^{N}−1 generators P\hat{ }ₙ due to the exclusion of the tensor product of N identity operators. The largest abelian (or Cartan) sub-algebra in su(2^{N}) that can be involve in the decomposition in this example is a set of P\hat{ }ₙ's that contain only \hat{ }zⱼ operators, denoted as Z\hat{ }ₙs. The CSA decomposition of G\hat{ } is

$$\hat{G} = \hat{{V}^{†}} ( {\sum }_{n = 1}^{K} {c}_{n} {\hat{Z}}_{n} ) \hat{V} , \qquad ( 15 )$$

where cₙ are coefficients, and V\hat{ } is a unitary transformation

$$\hat{V} = {\prod }_{k} {e}^{i {τ}_{k} {\hat{P}}_{k} ,} \qquad ( 16 )$$

Here, τₖ are real amplitudes, and P\hat{ }ₖs are all Pauli products that are not in the CSA. Each term in the sum of Eq. (15) has eigenvalues ±cₙ; therefore each O\hat{ }ₙ=cₙV\hat{ }^{†}Z\hat{ }ₙV\hat{ } can be chosen.

According to an embodiment, the CSA decomposition in Eq. (15) can be implemented by expanding the left- and right-hand sides of Eq. (15) in a basis of su(2^{N}) Lie algebra of P\hat{ }ₙ's to determine coefficients cₙ and amplitudes τₖ for V\hat{ }. This decomposition is unique in terms of the number of Z\hat{ }ₙ terms. This can facilitate determining the number of two-eigenvalue operators in the G\hat{ } decomposition.

According to an embodiment, since all O\hat{ }ₙ operators commute, the gradient expression can be expressed as application of the PSR to each O\hat{ }ₙ operator in G\hat{ }

$$\frac{\partial E}{\partial τ} = {\sum }_{n} \frac{1}{sin ( 2 {θ}_{n} )} [ \text{} 〈 {e}^{- i ( τ \hat{G} + {0}_{n} {\hat{O}}_{n} )} {\hat{H}}_{2} {e}^{i ( τ \hat{G} + i {0}_{n} {\hat{O}}_{n} )} 〉 - 〈 {c}^{- i ( τ \hat{G} - {0}_{n} {\hat{O}}_{n} )} {\hat{H}}_{2} {e}^{i ( τ \hat{G} - {0}_{n} {\hat{O}}_{n} )} 〉 ] . \qquad ( 17 )$$

The involved unitary transformations can be expressed as

$${e}^{\pm i ( τ \hat{G} \pm {θ}_{n} {\hat{O}}_{n} )} = {\hat{V}}^{†} {\prod }_{m = 1}^{K} {e}^{\pm {ic}_{m} ( τ \pm {δ}_{n m} {θ}_{n} ) {\hat{Z}}_{m}} \hat{V} . \qquad ( 18 )$$

This form enables improved implementation of these operators as a circuit, according to an embodiment.

Non-commutative Cartan sub-algebra decomposition: According to an embodiment, an alternative representation of G\hat{ } is a sum of non-commuting two-eigenvalue operators

$$\hat{G} = {\sum }_{n = 1}^{{K}^{′}} {c}_{n} {\hat{V}}_{n}^{†} {\hat{Z}}_{n} {\hat{V}}_{n} , \qquad ( 19 )$$

Here, V\hat{ }ₙs are defined in the same way as V\hat{ }. This decomposition defines O\hat{ }ₙ=cₙV\hat{ }ₙ^{†}Z\hat{ }ₙV\hat{ }ₙ, and due to differences in V\hat{ }ₙs, different O\hat{ }ₙs do not necessarily commute. The main advantage of the non-commutative decomposition is that it uses not only coefficients cₙ for reproducing the spectrum of G\hat{ } but also some parameters in V\hat{ }ₙ's, λⱼ=λⱼ({Vₙ}ₙ₌₁^{K′}, {cₙ}ₙ₌₁^{K′}).

According to an embodiment, this dependence can be implemented to allow the non-commutative decomposition to represent G\hat{ } with a lower number of terms K⁰<K (e.g., Eq. (19) and Eq. (15)). According to an embodiment, such lower number of terms can advantageously be used to improve quantum computation.

According to an embodiment, to construct the non-commutative decomposition, the number of terms K⁰ can be fixed to values lower than K in Eq. (15) and the difference between the left and right-hand sides of Eq. (19) can be minimized using cₙ and τₖ⁽ⁿ⁾ (amplitudes of V\hat{ }ₙ). The choice of Z\hat{ }ₙ in Eq. (19) can be insignificant because V\hat{ }ₙ can transform one CSA operator into another.

According to an embodiment, non-commutativity of O\hat{ }ₙ operators does not preclude use of the shift-rule to each O\hat{ }ₙ operator to obtain components of the derivative for the G\hat{ } amplitude

$$\frac{\partial E}{\partial τ} = {\sum }_{n} \frac{1}{sin ( 2 {θ}_{n} )} [ \text{} 〈 {e}^{- i {θ}_{n} {\hat{O}}_{n}} {e}^{- i τ \hat{G}} {\hat{H}}_{2} {e}^{i τ \hat{G}} {e}^{i {θ}_{n} {\hat{O}}_{n}} 〉 - 〈 {{e}^{i {θ}_{n}}}^{{\hat{O}}_{n}} {e}^{- i τ \hat{G}} {\hat{H}}_{2} {e}^{i τ \hat{G}} {e}^{- i {θ}_{n} {\hat{O}}_{n}} 〉 ] . \qquad ( 20 )$$

To measure such expectation values there is overhead related to non-compatibility of eigenstates for individual O\hat{ }ₙ and G\hat{ }. For each class of G\hat{ } operators, embodiments can be implemented based on whether the potential reduction in the number of terms in Eq. (19) is not diminished by a possible higher circuit depth.

In some embodiments, Generator G is decomposed into a linear combination of normal operators Oₙ with a low number of distinct eigenvalues (e.g., 2 or 3)

$$\hat{G} = {\sum }_{n = 1}^{K} {d}_{n} {\hat{O}}_{n} ,$$

where dₙ's are numerical coefficients from the field of real numbers. There are several choices for operators Oₙ, which vary in the number of terms K needed for the generator expansion. As described herein, several choices of operators Oₙ for generator decompositions can be implemented.

For N-qubit generators (in provided examples, N=2 and 3), there are 2 decompositions proposed: 1) commutative CSA decomposition:

$$\hat{G} = {\hat{V}}^{†} ( {\sum }_{n = 1}^{K} {c}_{n} {\hat{Z}}_{n} ) \hat{V} ,$$

where K is the number of terms, cₙ are coefficients, \hat{Z}ₙ's are product of Pauli z operators, and \hat{V} is a unitary transformation

$$\hat{V} = {\prod }_{k} {e}^{i {τ}_{k} {\hat{P}}_{k}} ,$$

with real amplitudes τₖ, and Pauli operator products \hat{P}ₖ; and 2) non-commutative CSA decomposition:

$$\hat{G} = {\sum }_{n = 1}^{{K}^{′}} {c}_{n} {\hat{V}}_{n}^{†} {\hat{Z}}_{n} {\hat{V}}_{n} ,$$

where K′ is the number of terms, \hat{V}ₙ's are unitary transformations defined in the same form as \hat{V}, cₙ are coefficients, and \hat{Z}ₙ's are product of Pauli z operators.

For fermionic operators, S²-conserving generators can be used and the commutative CSA scheme can be used. According to some embodiments, the only difference from the qubit implementation is that the Cartan sub-algebra for the fermionic algebra is based on polynomial functions of the occupation number operators.

### Applications

According to embodiments, application of the generator decompositions for gradient evaluations of several classes of challenging operators can be implemented: 1) 2-qubit generators, 2) 3-qubit generators, and 3) generators of S\hat{ }²-conserving fermionic rotations. This can help address inapplicability of the PSR for these generators due to the multitude of eigenvalues. As described, advantages of all three decomposition techniques can be illustrated using these as examples.

### 2-Qubit Generators

Any 2-qubit generator has not more than 4 different eigenvalues, and thus, the eigenvalue decomposition scheme will need 8 expectation values for a gradient evaluation, according to some embodiments. The CSA decomposition (Eq. (15)) of any 2-qubit generator results in at most 3 Z\hat{ }ₙs (\hat{ }z₁,z\hat{ }₂,z\hat{ }₁z\hat{ }₂), which leads to not more than 6 expectation values for each gradient. In all considered 2-qubit gates, commuting and non-commuting CSA decompositions provided the same number of O\hat{ }ₙs.

Transmon gates: Embodiments can implement transmon gates. These gates can be generated by

$$\hat{G} = {\hat{x}}_{1} - b {\hat{z}}_{1} {\hat{x}}_{2} + c {\hat{x}}_{2} . \qquad ( 21 )$$

Applying Ŵ(τ)=exp(iτŷ₁\hat{x}₂) to each term of G\hat{ }

$$\hat{{W}^{†}} ( τ ) {\hat{x}}_{1} \hat{W} ( τ ) = cos ( 2 τ ) {\hat{x}}_{1} - sin ( 2 τ ) {\hat{z}}_{1} {\hat{x}}_{2} \qquad ( 22 )$$

$$\hat{{W}^{†}} ( τ ) {\hat{z}}_{1} {\hat{x}}_{2} \hat{W} ( τ ) = cos ( 2 τ ) {\hat{z}}_{1} {\hat{x}}_{2} + sin ( 2 τ ) {\hat{x}}_{1} \qquad ( 23 )$$

$$\hat{{W}^{†}} ( τ ) {\hat{x}}_{2} \hat{W} ( τ ) = {\hat{x}}_{2} \qquad ( 24 )$$

one can choose τ₀ so that cos(2τ₀)=1/\sqrt{1+b²} and sin(2τ₀)=b/\sqrt{1+b²}, then G\hat{ } can be represented as

$$\hat{G} = {\hat{W}}^{†} ( {τ}_{0} ) [ \sqrt{1 + {b}^{2}} {\hat{x}}_{1} + c {\hat{x}}_{2} ] \hat{W} ( {τ}_{0} ) . \qquad ( 25 )$$

To arrive at the form of Eq. (15), V\hat{ } needs to be defined as

$$\hat{V} = {e}^{i \frac{π}{4} ( {\hat{y}}_{1} + {\hat{y}}_{2} )} \hat{W} ( {τ}_{0} ) \qquad ( 26 )$$

then Ô₁=\sqrt{1+b²}\hat{V}^{†}\hat{z}₁\hat{V} and Ô₂=c\hat{V}^{†}\hat{z}₂\hat{V}.

This decomposition allows a quantum computer to evaluate the gradient using only 4 expectation values. Embodiments can implement this decomposition and can evaluate the gradient using only 4 expectation values. This can enable implementation of improved 2-qubit generators. This can enable implementation of improved transmon gates. For example, in some embodiments, a quantum circuit of the quantum computer executes repeatedly to perform a sequence of operations that implements transmon gates and evaluates a gradient using only 4 expectation values.

According to some embodiments, a transmon gate generator is represented as Ĝ=Ŵ^{†}(τ₀)[\sqrt{1+b²}\hat{x}₁+c\hat{x}₂]Ŵ(τ₀), where Ŵ(τ)=exp(iτŷ₁\hat{x}₂), and τ₀ is obtained using the conditions cos(2τ₀)=1/\sqrt{1+b²} and sin(2τ₀)=b/\sqrt{1+b²}. Second, the generator is brought to the form

$$\hat{G} = {\hat{V}}^{†} ( {\sum }_{n = 1}^{K} {c}_{n} {\hat{Z}}_{n} ) \hat{V}$$

by using \hat{V}=e^{iπ/4(ŷ}^{₁}^{+ŷ}^{₂}⁾Ŵ(τ₀) then the generator is the sum of two operators: \sqrt{1+b²}\hat{V}^{†}\hat{z}₁\hat{V} and c\hat{V}^{†}\hat{z}₂\hat{V}. This decomposition requires only 4 expectation values to evaluate the gradient with respect to the amplitude of the generator, according to some embodiments.

Match-gates: Embodiments can implement match-gates. Embodiments can implement generators of these gates. Generators of these gates can be implemented as linear combinations of the following operators

$$\{ {\hat{x}}_{1} {\hat{x}}_{2} , {\hat{y}}_{1} {\hat{y}}_{2} , {\hat{x}}_{1} {\hat{y}}_{2} , {\hat{y}}_{1} {\hat{x}}_{2} , {\hat{𝓏}}_{1} , {\hat{𝓏}}_{2} \} . \qquad ( 27 )$$

This set forms a sub-algebra of su(4) that is a direct sum of two su(2) algebras

$${𝒜}_{1} = \{ \frac{{\hat{𝓏}}_{1} + {\hat{𝓏}}_{2}}{2} , \frac{{\hat{x}}_{1} + {\hat{y}}_{1} {\hat{x}}_{2}}{2} , \frac{{\hat{x}}_{1} {\hat{x}}_{2} - {\hat{y}}_{1} {\hat{y}}_{2}}{2} \} \qquad ( 28 )$$

$${𝒜}_{2} = \{ \frac{{\hat{𝓏}}_{1} - {\hat{𝓏}}_{2}}{2} , \frac{{\hat{y}}_{1} {\hat{x}}_{2} - {\hat{x}}_{1} {\hat{y}}_{2}}{2} , \frac{{\hat{x}}_{1} {\hat{x}}_{2} + {\hat{y}}_{1} {\hat{y}}_{2}}{2} \} . \qquad ( 29 )$$

Each su(2) has only one Cartan element. The CSA decomposition of any match-gate generator provides two O\hat{ }ₙ's, which are results of conjugation of two CSA elements, \hat{ }z₁ and \hat{ }z₂, with unitaries (V\hat{ }'s) from the two SU(2) groups corresponding to the su(2) algebras. This implementation can enable implementation of improved match-gates.

Embodiments can implement, using a quantum computer, generators of these gates as linear combinations as described. This can enable implementation of improved match-gates. For example, in some embodiments, a quantum circuit of the quantum computer executes repeatedly to perform a sequence of operations that implements match-gates (e.g., by implementing linear combinations of these operators).
1. According to some embodiments, the generator of the match-gate is Ĝ_{match}=aA₁⁽¹⁾+bA₂⁽¹⁾+cA₃⁽¹⁾+dA₁⁽²⁾+eA₂⁽²⁾+fA₃⁽²⁾ where {a, b, c, d, e, f} are numerical constants, and

$$\{ {A}_{1}^{( 1 )} , {A}_{2}^{( 1 )} , {A}_{3}^{( 1 )} \} = \{ \frac{{\hat{𝓏}}_{0} + {\hat{𝓏}}_{1}}{2} , \frac{{\hat{x}}_{0} {\hat{x}}_{1} - {\hat{y}}_{0} {\hat{y}}_{1}}{2} , \frac{{\hat{x}}_{0} {\hat{y}}_{1} + {\hat{y}}_{0} {\hat{x}}_{1}}{2} \}$$

$$\{ {A}_{1}^{( 2 )} , {A}_{2}^{( 2 )} , {A}_{3}^{( 2 )} \} = \{ \frac{{\hat{𝓏}}_{0} - {\hat{𝓏}}_{1}}{2} , \frac{{\hat{x}}_{0} {\hat{x}}_{1} + {\hat{y}}_{0} {\hat{y}}_{1}}{2} , \frac{- {\hat{x}}_{0} {\hat{y}}_{1} + {\hat{y}}_{0} {\hat{x}}_{1}}{2} \}$$

are operators forming two [symbol] (2) algebras. First, unitary transformations V₁ is defined as

$${\hat{V}}_{1} = {e}^{\frac{i}{2} arctan ( c / b ) {A}_{1}^{( 1 )}} {e}^{\frac{i}{2} arctan ( f / e )} {A}_{1}^{( 2 )}$$

whose action on the generator leads to

$${\hat{V}}_{1} \hat{G} {\hat{V}}_{1}^{†} = {aA}_{1}^{( 1 )} + {b}^{′} {A}_{2}^{( 1 )} + d {A}_{1}^{( 2 )} + {e}^{′} {A}_{2}^{( 2 )} .$$

Second, unitary transformations V₂ is defined as

$${\hat{V}}_{2} = {e}^{\frac{i}{2} arctan ( {b}^{′} / a ) {A}_{3}^{( 1 )}} {e}^{\frac{i}{2} arctan ( {e}^{′} / d )} {A}_{3}^{( 2 )} .$$

The combined action of V₁ and V₂ on the generator leads to

$${\hat{V}}_{2} {\hat{V}}_{1} \hat{G} {\hat{V}}_{1}^{†} {\hat{V}}_{2}^{†} = {a}^{′} {A}_{1}^{( 1 )} + {d}^{′} {A}_{1}^{( 2 )}$$

The generator can then be implemented in the following form:

$${\hat{G}}_{match} = {( {\hat{V}}_{2} {\hat{V}}_{1} )}^{†} ( \frac{{a}^{′} + {d}^{′}}{2} {\hat{𝓏}}_{0} + \frac{{a}^{′} - {d}^{′}}{2} {\hat{𝓏}}_{1} ) {\hat{V}}_{2} {\hat{V}}_{1} ,$$

where a′ and d′ are constants that are defined by the action of V₁ and V₂ transformations on the generator. The last representation of the match-gate generator allows one to evaluate its gradient with respect to the corresponding amplitude using 4 expectation values, according to some embodiments.

fSim gates: Embodiments can implement fSim gates. Embodiments can implement a fSim gate generator as follows

$${\hat{G}}_{fSim} = \frac{θ}{2} ( {\hat{x}}_{1} {\hat{x}}_{2} + {\hat{y}}_{1} {\hat{y}}_{2} ) + \frac{ϕ}{4} ( 1 - {\hat{𝓏}}_{1} ) ( 1 - {\hat{𝓏}}_{2} ) . \qquad ( 30 )$$

Its CSA decomposition results in 3 Z\hat{ }ₙ, therefore to do gradients with respect to the overall amplitude τ in exp(iτĜ_{fSim}) can require 6 expectation values. G\hat{ }_{fSim} can be split into

$${\hat{O}}_{1} = \frac{θ}{2} ( {\hat{x}}_{1} {\hat{x}}_{2} + {\hat{y}}_{1} {\hat{y}}_{2} ) , \qquad ( 31 )$$

$${\hat{O}}_{2} = \frac{ϕ}{4} ( 1 - {\hat{𝓏}}_{1} ) ( 1 - {\hat{𝓏}}_{2} ) \qquad ( 32 )$$

which have 3 and 2 eigenvalues respectively, thus the θ and φ gradients of exp(iĜ_{fSim}(θ, ϕ)) will require 4 and 2 expectation values. This implementation can enable implementation of improved fSim gates. For example, in some embodiments, a quantum circuit of the quantum computer executes repeatedly to perform a sequence of operations that implements these fSim gates (e.g., by implementing this decomposition) and evaluates these gradients using only 4 and 2 expectation values.

According to some embodiments, the fSim gate generator is

$${\hat{G}}_{fSim} = \frac{θ}{2} ( {\hat{x}}_{1} {\hat{x}}_{2} + {\hat{y}}_{1} {\hat{y}}_{2} ) + \frac{ϕ}{4} ( 1 - {\hat{𝓏}}_{1} ) ( 1 - {\hat{𝓏}}_{2} ) .$$

To evaluate the gradient with respect to the overall amplitude τ in the unitary transformation exp(iτĜ_{fSim}) will require 6 expectation values, according to some embodiments. The CSA decomposition which is used for that is

$${\hat{G}}_{fSim} = \frac{θ}{2} {\hat{V}}^{†} ( {\hat{𝓏}}_{1} + {\hat{𝓏}}_{2} ) \hat{V} + \frac{ϕ}{4} ( 1 - {\hat{𝓏}}_{1} ) ( 1 - {\hat{𝓏}}_{2} )$$

$$where \hat{V} = {e}^{\frac{i π}{4} ( {\hat{y}}_{2} - {\hat{x}}_{1} )} {e}^{\frac{i π}{4} ( {\hat{y}}_{1} {\hat{𝓏}}_{2} - {\hat{𝓏}}_{1} {\hat{x}}_{2} )} .$$

The gradients of exp(iĜ_{fSim}(θ, ϕ)) with respect to θ and ϕ are evaluated using the same CSA decomposition and require 4 and 2 expectation values respectively, according to some embodiments.

### 3-Qubit Generators

According to an embodiment, an example of a 3-qubit transformation where the advantage of implementation of a non-commutative CSA decomposition over a commutative CSA scheme is provided.

As an example, there is a generator

$$\hat{G} = {Û}^{†} {\hat{𝓏}}_{1} Û + {\hat{𝓏}}_{2} \qquad ( 33 )$$

that requires only 2 O\hat{ }ₙ's using the non-commuting scheme. A three-qubit unitary Û=exp(Â) is selected, where A\hat{ } is an anti-Hermitian operator with the following matrix representation: A_{i,i}=0, A_{i,j<i}=1, and A_{i,j>i}=−1. The CSA decomposition of G\hat{ }

$$\hat{G} \approx {\hat{V}}^{†} ( 1.2 \; 50 {\hat{𝓏}}_{1} {\hat{𝓏}}_{2} + 0.0 \; 45 {\hat{𝓏}}_{1} {\hat{𝓏}}_{2} {\hat{𝓏}}_{3} + 0.0 \; 14 {\hat{𝓏}}_{1} {\hat{𝓏}}_{3} + 0.658 {\hat{𝓏}}_{2} - 0.0 \; 45 {\hat{𝓏}}_{2} {\hat{𝓏}}_{3} + 0.0 \; 14 {\hat{𝓏}}_{3} ) \hat{V} \qquad ( 34 )$$

indicates that there are at least 6 O\hat{ }ₙ's (12 expectation values) for the commutative decomposition scheme. The non-commutative CSA scheme requires fewer expectation values, according to an embodiment.

Embodiments can implement this decomposition. This can enable implementation of improved 3-qubit generators. For example, in some embodiments, a quantum circuit of the quantum computer executes repeatedly to perform a sequence of operations that implements 3-qubit generators using this non-commutative decomposition scheme.

### S\hat{ }²-Conserving Fermionic Generators

According to some embodiments, S\hat{ }²-conserving fermionic generators are implemented as described herein. According to some embodiments, such generators are linear combinations of products of creation and annihilation fermionic operators with coefficients restricted to satisfy three commutativity conditions with the number of electrons, electron spin, and the z-projection of the electron spin operators.

Embodiments can construct a pool of generators for application of VQAs to solving the electronic structure problems by adding symmetry conserving conditions. For example, in some embodiments, a quantum circuit of the quantum computer executes repeatedly to perform a sequence of operations that implements generators or operators described herein.

UCC single and double operators

$${\hat{κ}}_{i}^{a} = {a}_{a}^{†} {a}_{i} - {a}_{i}^{†} {a}_{α} \qquad ( 35 )$$

$${\hat{κ}}_{ji}^{ab} = {a}_{a}^{†} {a}_{b}^{†} {a}_{i} {a}_{j} - {a}_{j}^{†} {a}_{i}^{†} {a}_{b} {a}_{α} \qquad ( 36 )$$

conserve the number of electrons but not the electron spin. Unitary generators that commute with the electron spin operators, S\hat{ }_{z} and S\hat{ }², can be obtained by antihermitization of singlet spherical tensor operators. A general spherical tensor operator, T\hat{ }^{S,M}, is defined as

$$[ {\hat{S}}_{\pm } , {\hat{T}}^{S , M} ] = \sqrt{S ( S + 1 ) - M ( M \pm 1 )} {\hat{T}}^{S , M \pm 1} , \qquad ( 37 )$$

$$[ {\hat{S}}_{z} , {\hat{T}}^{S , M} ] = M {\hat{T}}^{S , M} , \qquad ( 38 )$$

where S and M are electron spin and its projection to the z-axis, respectively. Equation S\hat{ }²=S\hat{ }₋S\hat{ }₊+S\hat{ }_{z}(S\hat{ }_{z}+1) can be used to show that any singlet spherical tensor operator, T\hat{ }^{0,0} will commute with S\hat{ }_{z} and S\hat{ }².

There are approaches for producing spherical tensor operators, and they involve very similar techniques to those used for generating spin-adapted configuration state functions. Individual single excitations are not T\hat{ }^{0,0} operators, therefore, one needs to group more than one excitation to obtain singlet operators

$${\hat{T}}_{ia}^{0 , 0} = {\hat{κ}}_{{i}_{α}}^{{a}_{α}} + {\hat{κ}}_{{i}_{β}}^{{a}_{β}} , \qquad ( 39 )$$

Here and further a_{α}(a_{β}) and i_{α}(i_{β}) are the spin orbitals arising from the α(β) spin parts of the a^{th} and i^{th} spatial orbitals. For double and higher excitations/deexcitations, the seniority number Ω (the number of unpaired electrons created by the operator) correlates well with the number of individual excitation/de-excitation pairs in construction of singlet operators

$$\begin{matrix}Ω = 0 : & {\hat{T}}_{ii aa}^{0 , 0} =\end{matrix} {\hat{κ}}_{{i}_{α} {i}_{β}}^{{a}_{α} {a}_{β}} , \qquad ( 40 )$$

$$\begin{matrix}Ω = 2 : & {\hat{T}}_{ii ab}^{0 , 0} =\end{matrix} {\hat{κ}}_{{i}_{α} {j}_{β}}^{{a}_{α} {b}_{β}} + {\hat{κ}}_{{i}_{α} {i}_{β}}^{{a}_{β} {b}_{α}} , \qquad ( 41 )$$

$$\begin{matrix}Ω = 2 : & {\hat{T}}_{ij aa}^{0 , 0} =\end{matrix} {\hat{κ}}_{{i}_{α} {j}_{β}}^{{a}_{α} {a}_{β}} + {\hat{κ}}_{{i}_{β} {j}_{α}}^{{a}_{α} {a}_{β}} , \qquad ( 42 )$$

$$\begin{matrix}Ω = 4 : & {\hat{T}}_{i j a b}^{0 , 0} = {\sum }_{s , \overline{s} ∈ \{ α , β \}}\end{matrix} {\hat{κ}}_{{i}_{s} {j}_{\overline{s}}}^{{a}_{\overline{s}} {b}_{s}} . \qquad ( 43 )$$

Generators in Eqs. (39) and (40) to (43) are used for spin-conserving UCC singles and doubles ansatz.

The spectrum of the spin-conserving generators are reported in Table I. It is important to note that the zero eigenvalue has much higher multiplicity than the nonzero eigenvalues for the single and double spherical tensor operators. Due to large differences between multiplicities of different eigenvalues in the singlet operators' spectra, their decomposition following Eq. (15) may be inefficient in K. It may takes a lot of {±1}-eigenvalued operators to create large variations in eigenvalues' multiplicities. Furthermore, due to parity symmetry of the spectra, it is natural to introduce alternative O\hat{ }ₙ's in Eq. (9) which have 3 eigenvalues {0, ±λₙ}. Explicit forms of the O\hat{ }ₙ operators for each singlet spherical operator are as follows and can be implemented according to an embodiment.

TABLE I
The eigenvalues for the singlet single and double fermionic operators.
Multiplicities are provided as subscripts.

| Singlet operator | Eigenvalues |
|---|---|
| \hat{T}ᵢₐ^{0,0} | {0₆, ±i₄, ±i2₁} |
| \hat{T}ᵢᵢₐₐ^{0,0} | {0₁₄, ±i₁} |
| \hat{T}ᵢⱼₐₐ^{0,0}, \hat{T}_{iiab}^{0,0} | {0₅₂, ±i₄, ±i\sqrt{2}₂ |
| \hat{T}_{ijab}^{0,0} | {0₁₈₆, ±i₁₆, ±i\sqrt{2}₁₆, ±i2₂, ±i2\sqrt{2}₁} |

\hat{T}ᵢₐ^{0,0} = Ô₁ + Ô₂:
λ ∈ {0, ±i}: Ô₁ = \hat{κ}ᵢ_{_{α}}^{a}^{_{α}} (\hat{n}ᵢ_{_{β}} − \hat{n}ₐ_{_{β}})² + \hat{κ}ᵢ_{_{α}}^{a}^{_{α}} (\hat{n}ᵢ_{_{α}} − \hat{n}ₐ_{_{α}})²
λ ∈ {0, ±i2}: Ô₂ = \hat{T}ᵢₐ^{0,0} − Ô₁ \hat{T}_{iiab}^{0,0} = Ô₁ + Ô₂:
λ ∈ {0, ±i}: Ô₁ = \hat{κ}ᵢ_{_{α}}ᵢ_{_{β}}^{a}^{_{β}}^{b}^{_{α}} (\hat{n}ₐ_{_{α}} − \hat{n}_{b}_{_{β}})² + \hat{κ}ᵢ_{_{α}}ᵢ_{_{β}}^{a}^{_{β}}^{b}^{_{α}} (\hat{n}ₐ_{_{α}} − \hat{n}_{b}_{_{β}})²
λ ∈ {0, ±i\sqrt{2}}: Ô₂ = \hat{T}_{iiab}^{0,0} − Ô₁ \hat{T}ᵢⱼₐₐ^{0,0} = Ô₁ + Ô₂:
λ ∈ {0, ±i}: Ô₁ = \hat{κ}ᵢ_{_{β}}ⱼ_{_{α}}^{a}^{_{α}}^{b}^{_{β}} (\hat{n}ᵢ_{_{α}} − \hat{n}ⱼ_{_{β}})² + \hat{κ}ᵢ_{_{β}}ⱼ_{_{α}}^{a}^{_{α}}^{b}^{_{β}} (\hat{n}ᵢ_{_{α}} − \hat{n}ⱼ_{_{β}})²,
λ ∈ {0, ±i\sqrt{2}}: Ô₂ = \hat{T}ᵢⱼₐₐ^{0,0} − Ô₁;
${\hat{T}}_{ijab}^{0 , 0} = {\sum }_{i = 1}^{4} {\hat{O}}_{i} : λ ∈ \{ 0 , \pm i 2 \} : {\hat{O}}_{1} = {\sum }_{s , \overline{s} ∈ \{ α , β \}} {\hat{κ}}_{{i}_{s} {j}_{\overline{s}}}^{{a}_{\overline{s}} {b}_{s}} ( {\hat{n}}_{{a}_{s}} {\hat{n}}_{{i}_{\overline{s}}} ( 1 - {\hat{n}}_{{j}_{s}} ) + {\hat{n}}_{{b}_{s}} {\hat{n}}_{{j}_{s}} ( 1 - {\hat{n}}_{{i}_{s}} ) - {\hat{n}}_{{a}_{s}} {{\hat{n}}_{{b}_{s}} ( {\hat{n}}_{{i}_{s}} - {\hat{n}}_{{j}_{s}} )}^{2} ) ,$ $λ ∈ \{ 0 , \pm i \sqrt{2} \} : {\hat{O}}_{3} = {\sum }_{s , \overline{s} ∈ \{ α , β \}} {\hat{κ}}_{{i}_{s} {j}_{\overline{s}}}^{{a}_{\overline{s}} {b}_{s}} ( {( {\hat{n}}_{{i}_{s}} - {\hat{n}}_{{b}_{s}} )}^{2} + {( {\hat{n}}_{{j}_{s}} - {\hat{n}}_{{a}_{s}} )}^{2} ) - 2 ( {\hat{O}}_{1} + {\hat{O}}_{2} ) ,$ $λ ∈ \{ 0 , \pm i 2 \sqrt{2} \} : {\hat{O}}_{2} = {\sum }_{s , \overline{s} ∈ \{ α , β \}} {\hat{κ}}_{{i}_{s} {j}_{\overline{s}}}^{{a}_{\overline{s}} {b}_{s}} ( {\hat{n}}_{{i}_{\overline{s}}} {\hat{n}}_{{j}_{s}} ( 1 - {\hat{n}}_{{a}_{s}} ) + {\hat{n}}_{{a}_{s}} {\hat{n}}_{{b}_{\overline{s}}} ( 1 - {\hat{n}}_{{i}_{\overline{s}}} ) - {\hat{n}}_{{j}_{s}} {{\hat{n}}_{{b}_{\overline{s}}} ( {\hat{n}}_{{i}_{\overline{s}}} - {\hat{n}}_{{a}_{s}} )}^{2} ) ,$ $λ ∈ \{ 0 , \pm i \} : {\hat{O}}_{4} = {\hat{T}}_{ijab}^{0 , 0} - {\sum }_{i = 1}^{3} {\hat{O}}_{i} ,$

where \hat{ }nₚ=a\hat{ }^{†}ₚa\hat{ }ₚ. For Ω=0, \hat{T}ᵢᵢₐₐ^{0,0} has only one nonzero eigenvalue and thus does not require a decomposition.

In electronic structure calculations, owing to timereversal symmetry of the electronic Hamiltonians, unitary transformations generating real-valued wavefunctions are implemented according to embodiments. Therefore, reducing the number of expectation values for real fermionic wave-functions from 4 to 2 such as described herein is applicable for the singlet spherical tensor operators as well. This advantageously allows for an implementation using not more than 8 expectation values for evaluating gradients in the most complicated case of Ω=4 according to embodiments.

Embodiments provide two implementations for generalization of the parametric-shift-rule based on the polynomial expansion of exponentially parametrized unitary transformations and the generator decompositions. As in the original parametric-shift-rule application, these implementations provide gradient expressions as linear combinations of expectation values, where the main criterion for efficiency is the number of different expectation values.

Both of the implementations use the eigen-spectrum of the generator, but in different ways. The performance of the polynomial expansion depends on the number of different eigenvalues, while that of the generator decompositions depends also on the generator eigen-subspaces and how well their structures can be reproduced by decomposing operators. The polynomial expansion implementation scales quadratically with the number of generator eigenvalues and provides efficient expression for 2- and 3-eigenvalue generators. For generators with a larger number of eigenvalues it is beneficial to employ the generator decomposition technique.

The generator decomposition implementation has several variations differing in low-eigenvalue operators used for the decomposition. A conservative approach is to use projectors on individual eigen-subspaces; its number of expectation values scales linearly with the number of the generator eigenvalues. This was found to provide advantages over other decompositions such as if one of the generator eigenvalues has much higher multiplicity than the other eigenvalues, as in the case of S²-conserving fermionic operators.

Another alternative implementation for decomposing generators is using the Cartan sub-algebra (CSA), according to embodiments. For some generators whose different eigenvalues can be related via linear combinations with binary coefficients and have similar degeneracies, the CSA decomposition implementation can reduce the generator expansion to scale as log2 of the number of eigenvalues. Results of the CSA decomposition can be further improved where the implementation allows generation of non-commutative terms. The CSA based implementations can show that any 2-qubit transmon and match-gates can be implemented using only 4 expectation values for their gradients, according to embodiments.

According to an embodiment, Eq. (6) can be implemented by deriving same as described below, and embodiments can implement determining coefficients Cₙ in Eq. (5) for generator G\hat{ } that has L eigenvalues. First, to find aᵢ(θ)'s in Eq. (6) an eigen-space projector decomposition of G\hat{ } can be used:

$$\hat{G} = {\sum }_{n = 1}^{L} {\hat{P}}_{n} {λ}_{n} , \qquad ( 44 )$$

where λₙ are different eigenvalues of G\hat{ } and P\hat{ }ₙ are projectors on the corresponding eigen-subspaces. Properties of these projectors are their orthogonality and idempotency (P\hat{ }ₙP\hat{ }ₘ=δₙₘP\hat{ }ₙ). These properties allow connecting the exponential function

$${e}^{i θ \hat{G}} = {\sum }_{n = 1}^{L} {\hat{P}}_{n} {e}^{i θ {λ}_{n}} , \qquad ( 45 )$$

with its polynomial expansion

$${\sum }_{k = 0}^{L - 1} {a}_{k} ( θ ) {( i \hat{G} )}^{k} = {\sum }_{n = 1}^{L} {\hat{P}}_{n} {\sum }_{k = 0}^{L - 1} {a}_{k} ( θ ) {( i {λ}_{n} )}^{k} . \qquad ( 46 )$$

Due to linear independence of projector operators this can allow implementations to provide a system of linear equations with {i^{k}aₖ(θ)} as variables

$$\begin{matrix}{\sum }_{k = 0}^{L - 1} {λ}_{n}^{k} [ {i}^{k} {a}_{k} ( θ ) ] = {e}^{i {θλ}_{n}} , & n = 1 , … , L .\end{matrix} \qquad ( 47 )$$

The matrix involved in this system of equations is the Vandermode matrix (λₙ^{k}=Wₙₖ), whose determinant is non-zero as long as the eigenvalues are different. Inverting the Vandermode matrix provide aₖ(θ) solutions

$${a}_{k} ( θ ) = {i}^{- k} {\sum }_{n} {W}_{kn}^{- 1} {e}^{i θ {λ}_{n}} . \qquad ( 48 )$$

Since λₙs are real, the following relations can be shown and implemented according to embodiments

$${a}_{2 k} ( θ ) = {a}_{2 k}^{*} ( - θ ) , \qquad ( 49 )$$

$${a}_{2 k + 1} ( θ ) = - {a}_{2 k + 1}^{*} ( - θ ) . \qquad ( 50 )$$

Second, Cₙ coefficients in Eq. (5) are also solutions of a linear system of equations. This system can be formulated by rewriting Eq. (5) as

$$\begin{matrix}{\sum }_{n} {C}_{n} 〈 {e}^{- i {θ}_{n} \hat{G}} \tilde{H} {e}^{i {θ}_{n} \hat{G}} 〉 = {\sum }_{n} {C}_{n} {\sum }_{k , {k}^{′} = 0}^{L - 1} 〈 {\hat{G}}^{{k}^{′}} \tilde{H} {\hat{G}}^{k} 〉 {A}_{{kk}^{′}} ( {θ}_{n} ) \\ = i [ 〈 \tilde{H} \hat{G} 〉 - 〈 \hat{G} \tilde{H} 〉 ] ,\end{matrix} \qquad ( 51 )$$

$$\tilde{H} = {e}^{- i τ \hat{G}} {\hat{U}}_{2}^{†} \hat{H} {\hat{U}}_{2} {e}^{i τ \hat{G}} , \qquad ( 52 )$$

$$where$$

$${A}_{{kk}^{′}} ( {θ}_{n} ) = {a}_{k} ( {θ}_{n} ) {a}_{{k}^{′}}^{*} ( {θ}_{n} ) {{i}^{k + {k}^{′}} ( - 1 )}^{k} . \qquad ( 53 )$$

Accounting for linear independence of [symbol] Ĝ^{k′}\tilde{H}Ĝ^{k} [symbol] terms, one can obtain Cₙ from equations

$${\sum }_{n} {A}_{{kk}^{′}} ( {θ}_{n} ) {C}_{n} = {B}_{{kk}^{′}} , \qquad ( 54 )$$

where B₁₀=−B₀₁=i and B_{kk′}=0 for all other kk′. Depending on the choice of θₙ, the number of Cₙ to satisfy L² equations can vary, but it may not exceed L². Minimization of the number of Cₙ coefficients and thus the number of expectation values can depend on the G\hat{ } spectrum. For example, if every in λₙ has its negative counterpart, −λₙ, then the even (odd) degree functions a₂ₖ(θ)(a₂ₖ₊₁(θ)) are real even (odd) θ functions. This allows one to reduce the number of Cₙ and θₙ parameters to ˜L²/2, where θₙ's are chosen in pairs {±θₖ}ₖ₌₁^{N}^{ₚ}^{/2}.

Thus, in the case of L=2, the number of Cₙs is only 2 because θₙ=±θ creates some dependencies in Aₖₖ_{⁰}(θₙ) elements. For L=3 and λₙ∈{0, ±1} the following polynomial expansion of the exponential G\hat{ } operator can be derived and implemented

$${e}^{i θ \hat{G}} = 1 + i sin ( θ ) \hat{G} + ( cos ( θ ) - 1 ) {\hat{G}}^{2} . \qquad ( 55 )$$

Taking θ_{1,2}=±θ does not eliminate terms [symbol] Ĝ\tilde{H}Ĝ² [symbol] and [symbol] Ĝ²\tilde{H}Ĝ [symbol] in the PSR expression; therefore another pair of θ's θ_{3,4}=±2θ are needed to eliminate these terms and to obtain the gradient of energy in this case. Here, according to embodiments, the final expression is implemented

$$i 〈 [ \tilde{H} , \hat{G} ] 〉 = ( α {Δ}_{1} - {Δ}_{2} ) β , \qquad ( 56 )$$

$$where$$

$$α = \frac{sin ( 2 θ ) ( cos ( 2 θ ) - 1 )}{sin ( θ ) ( cos ( θ ) - 1 )} , \qquad ( 57 )$$

$$β = {\frac{1}{2 sin ( 2 θ )} [ \frac{1 - cos ( 2 θ )}{1 - cos ( θ )} - 1 ]}^{- 1} , \qquad ( 58 )$$

$${Δ}_{k} = 〈 {e}^{- ik θ \hat{G}} \tilde{H} {e}^{ik θ \hat{G}} 〉 - 〈 {e}^{ik θ \hat{G}} \tilde{H} {e}^{- ik θ \hat{G}} 〉 . \qquad ( 59 )$$

This allows for 4 expectation values required to obtain the gradient with respect to the amplitude of the L=3 G\hat{ } with the symmetric eigenvalue spectrum λₙ∈{0, ±1}. This implementation advantageously provides a reduced number of expectation values and improved quantum computation, processing, speed, and feasibility.

The present description also relates to an efficient automatically differentiable, adaptable, and extendable framework for computing molecular properties using unitary operators executable on quantum computers. The disclosure relates to the decomposition of fermionic excitation generators into directly differentiable operators. Those operators can generate parameterized unitary operations executable on a quantum computer to generate/approximate an eigenenergy value of a quantum chemical Hamiltonian. Through the described decomposition the gradients of those unitary operations can be efficiently evaluated on the quantum computer. According to an embodiment, fermionic excitations are extended to the spin conserving case as described herein, as well as beyond fermionic generators to 2- and 3-qubit generators.

According to an embodiment, the present description relates to directly differentiable decompositions of generators for fermionic excitations within the unitary coupled-cluster framework, as well as within combinations with other quantum circuits, applicable for near term quantum computers. According to an embodiment, the present description relates to a wider class of generators beyond the unitary coupled-cluster framework.

According to an embodiment there is provided a computer-implemented method and system for implementing a n-fold fermionic excitation generator using linear combination of directly differentiable operators on a quantum computer. Computer-readable data is generated and stored which when executed on the quantum computer, causes a quantum circuit of the quantum computer to execute repeatedly to perform a sequence of operations that implements the unitary

$${e}^{- i \frac{θ}{2} G}$$

generated by a fermionic n-fold excitation operator G. The Gradient with respect to the angle θ of arbitrary expectation values involving the unitary operation can, in the general case, be evaluated by four expectation values obtained from replacing the corresponding unitary with fermionic shift operations

$${U}_{\pm }^{α} ( θ ) = {U}_{\pm } ( θ ) {U}_{0}^{α} = {e}^{- i \frac{1}{2} ( θ \pm \frac{π}{2} ) G} {e}^{- α \frac{i}{2} ( \pm \frac{π}{2} ) {P}_{0}} .$$

In the case of real wavefunctions the procedure can be reduce to the evaluation of two expectation values. Fermionic shift operations can be constructed through the original unitary and unitary operations generated by the nullspace projector P₀ of the fermionic excitation generator. The Nullspace projectors can be constructed in the fermionic representation as P_{0;pq}=1−Nₚ_{₀}Ñ_{q}_{₀} . . . Nₚ_{ₙ}Ñ_{q}_{ₙ}−N_{q}_{₀}Ñₚ_{₀} . . . N_{q}_{ₙ}Ñₚ_{ₙ} and encoded into qubits.

In some embodiments, there is provided a method implemented on a quantum computer for generating directly differentiable excitation operators. Generators of unitary coupled cluster operators are decomposed into directly differentiable operators to reduce the cost of their analytical gradients to a constant factor of four in the general case and two for real wavefunctions. An alternative strategy introduced in another embodiment involves modified generators that are directly differentiable. Applications include determination of ground and excited state energies of chemical systems using directly differentiable excitation operators. For example, the exact generators of unitary coupled-cluster operators can be decomposed into two self inverse operators using their nullspace projectors. In the general case the gradient of expectation values involving those unitaries can be evaluated by accumulating four expectation values where the corresponding unitary operations are replaced by fermionic-shift unitaries constructed from the excitation generators and their nullspace projectors. This can lead to a significant decrease in their numerical and computational cost, in some embodiments. This can provide for an improved calculation on a quantum computer, improving the quantum computing technology for more feasible and efficient determination of eigenenergy values or other properties of a system represented by a Hamiltonian, such as a chemical Hamiltonian.

According to an embodiment, a fermionic n-fold excitation operator is defined in function (A1) and (A2). Per function (A2), G is the Hermitian generator for n-fold excitation and p, q label arbitrary sets of spin-orbitals. The generators have distinct eigenvalues of ±1 and 0, the eigenvalue 0 corresponds to the subspace of states where they act trivially, and the eigenvalues ±1 correspond to states where the generators act non-trivially.

$$U ( θ ) = {e}^{- i \frac{θ}{2} {G}_{p q}} \qquad ( A1 )$$

$${G}_{p q} = i ( {\prod }_{n} {a}_{{p}_{n}}^{†} {a}_{{q}_{n}} - h . c . ) \qquad ( A2 )$$

According to an embodiment, the generator of the fermionic n-fold excitation G can be written as the sum over the projectors P₊, P₋ and P₀ onto the eigenfunctions of G, multiplied by their corresponding eigenvalues ±1 and 0. This can allow for the decomposition of the generated unitary corresponding to the generator into two directly differentiable parts. This decomposition can allow for the use of analytical gradients at a cost that is four times the number of the parameters to provide a way for black box optimization. The analytical form of the generator and unitary is shown in function (A3), and (A4).

$$G = {P}_{+} + {P}_{-} \qquad ( A3 )$$

$${e}^{- i \frac{θ}{2} G} = {e}^{- i \frac{θ}{2} {P}_{+} {e}^{- i \frac{θ}{2} P -}} \qquad ( A4 )$$

According to an embodiment, the eigenvalues of the generator for the differentiated unitary transformation is used for an efficient decomposition and differentiation scheme. A small number of unique eigenvalues allows for the efficient decomposition. In the foregoing example, all generators may have only three eigenvalues. According to an embodiment, a connection between eigenvalues and efficient decomposition for an arbitrary generator is implemented.

In another embodiment, there is a provided an alternate decomposition of the fermionic n-fold excitation generator G in terms of two modified directly differentiable generators G_{±}=G±P₀, wherein P₀ is a projector onto an eigenspace of G, wherein P₀ has an eigenvalue of zero. The analytical form of the exact and modified generators, and their corresponding unitaries are given in function (A5) and (A6) respectively,

$$G = \frac{1}{2} ( {G}_{+} + {G}_{-} ) \qquad ( A5 )$$

$${e}^{- i \frac{θ}{2} G} = cos ( \frac{θ}{2} ) 1 - i sin ( \frac{θ}{2} ) G + ( 1 - cos ( \frac{θ}{2} ) ) {P}_{0} \qquad ( A6 )$$

According to an embodiment, the analytical gradient of the n-fold excitations can be evaluated by combining the parameter shift rule with the product rule of calculus. This can lead to a constant cost factor of four, meaning four expectation values of similar cost may have to be estimated to calculate the analytical gradient. The expression for the analytical gradient and the unitaries are given in function (A7) and (A8).

$$\frac{\partial {〈 H 〉}_{X U ( θ ) Y}}{\partial θ} = \frac{1}{4} {\sum }_{α ∈ \{ + , - \}} ( {〈 H 〉}_{X {U}_{+}^{α} Y} - {〈 H 〉}_{{XU}_{-}^{α} Y} ) \qquad ( A7 )$$

$${U}_{\pm }^{α} ( θ ) = {U}_{\pm } ( θ ) {U}_{0}^{α} = {e}^{- i \frac{1}{2} ( θ \pm \frac{π}{2} ) G} {e}^{- α \frac{i}{2} ( \pm \frac{π}{2} ) {P}_{0}} \qquad ( A8 )$$

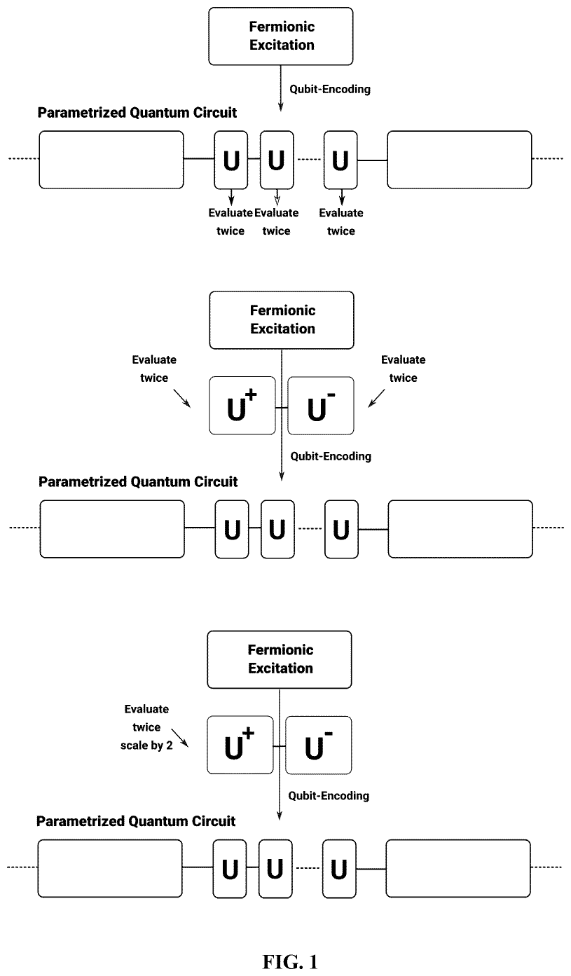

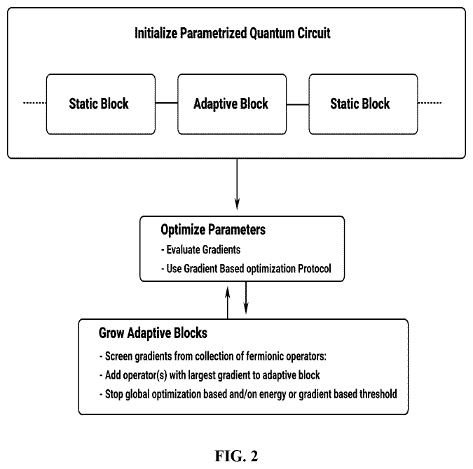

FIG. 1 shows a schematic overview over approaches for calculating analytical gradients on the qubit level using the shift rule, and the general gradient evaluation schemes on the fermionic level according to function (A7) as well as for real wavefunctions according to function (A9), according to some embodiments. FIG. 2 shows a schematic diagram to illustrate the incorporation of automatically differentiable fermionic excitations into generalized adaptive circuit construction schemes.

In another embodiment, the cost of calculating analytical gradient for real wavefunctions shown in function (A9) further reduces to a smaller factor of two expectation value calculations, wherein α can be either + or −. According to some embodiments, this technique allows the system to reduce by factor of two the number of expectation values for S²-conserving fermionic generators because all Oₙ operators appearing in the CSA decomposition for these generators are real. Without this technique, the number of expectation values for each Oₙ operator is four while with this technique it is two.

$$\frac{\partial {〈 H 〉}_{X U ( θ ) Y}}{\partial θ} = \frac{1}{2} ( {〈 H 〉}_{X {U}_{+}^{α} Y} - {〈 H 〉}_{{XU}_{-}^{α} Y} ) \qquad ( A9 )$$

According to some embodiments, there are provided various approximations that can be made to reduce the cost of calculating analytical gradients when dealing with complex wavefunctions to two, by using a modified generator by only using either G₊ or G₋ or equivalently as P_{±}. The analytical gradient is calculated using the shift-rule method. The form of the generators are shown in function (A11) and (A12) respectively.

$${G}_{\pm } = G \pm {P}_{0} \qquad ( A11 )$$

$${P}_{\pm } = \frac{1}{2} ( {G}_{\pm } \pm 1 ) \qquad ( A12 )$$

In some embodiments, there is provided a method performed by a classical computer for implementing, on a quantum computer, a n-fold fermionic excitation operator using directly differentiable excitation operators. The classical computer includes a processor, a non-transitory computer-readable medium, and computer program instructions stored in the non-transitory computer-readable medium. The processor executes the computer program instructions to generate or store, in the non-transitory computer-readable medium, computer-readable data, such as instructions, that, when executed on the quantum computer, configures one or more quantum circuits of the quantum computer. The quantum computer has a plurality of qubits. The quantum circuit is configured to execute repeatedly to perform a sequence of operations that realizes the excitation operator

$${e}^{- i \frac{θ}{2} G} .$$

In some embodiments the sequence of operations is obtained by mapping the generator G to products of pauli matrices and decomposing the generated unitary operations into primitive quantum gates. In the Jordan-Wigner representation, qubit states directly resemble fermionic fock-space occupation number vectors and creation/annihilation operators mapped to σ⁺/σ⁻ operators as well as σ^{z} operators as per functions (A14) and (A15).

$${a}_{k} = {1}^{⊗ k - 1} {σ}_{k}^{+} {σ}_{z}^{⊗ n - k} \qquad ( A14 )$$

$${a}_{k}^{†} = {1}^{⊗ k - 1} {σ}_{k}^{-} {σ}_{z}^{⊗ n - k} \qquad ( A15 )$$

The repeated execution can be according to a variational optimization algorithm like VQE where the gradient or higher order derivatives enter the objective function either directly or indirectly over a gradient based optimization strategy, (as well as combinations thereof), for example, and can iteratively optimize parameters of the quantum circuit to approximate the directly differentiable excitation operator, with values during each iteration being stored in one or more qubits and with new parameters for the quantum circuit being initialized by a classical computer at the end of each iteration based on an output or measured value from the quantum circuit.

According to an embodiment, the construction of the fermionic shift gate can be carried out by only constructing the null space projector P₀ of the fermionic generator along with the original fermionic generator G. The construction of the modified G_{±} or P_{±} may not be required explicitly for implementing the exact fermionic shift gate, but can be used for alternate implementations, and can be carried out using the null space projector P₀ and fermionic generator G as per function (A11) and (A12).

According to an embodiment, the framework is independent of the fermion-to-qubit transformation and can be constructed in the fermionic representation directly using excitation generators and their corresponding nullspace projectors.

According to a further embodiment, extensions to projectors and inclusions may be constructed prior to encoding into the qubits. The null-space projector onto the eigenstates of the n-fold fermionic excitation generators can be constructed using fermionic particle and hole number operators N_{pq}=aₚ^{†}a_{q} and Ñ_{pq}=1−N_{pq}=aₚa_{q}^{†}, and the expression is given in function (A19).

$${P}_{0 ; p q} = 1 - {N}_{{p}_{0}} {Ñ}_{{q}_{0}} … {N}_{{p}_{n}} {Ñ}_{{q}_{n}} - {N}_{{q}_{0}} {Ñ}_{{p}_{0}} … {N}_{{q}_{n}} {Ñ}_{{p}_{n}} \qquad ( A19 )$$

According to another embodiment, function (A17) denotes the null-space projector onto the eigenstates of the n-fold fermionic excitation generators explicitly constructed in the Jordan-Wigner representation as per functions (A14) and (A15) written as in function (A18), where

$${Q}_{\pm } = \frac{1 + {σ}^{\pm }}{2} .$$

$${P}_{0 ; p q} = 1 - {\prod }_{i = 1}^{N} ( {Q}_{-} ( {p}_{i} ) ) ( {Q}_{+} ( {q}_{i} ) ) + ( {Q}_{+} ( {p}_{i} ) ) ( {Q}_{-} ( {q}_{i} ) ) \qquad ( A18 )$$

According to an embodiment, there is provided details on the additional cost to implement the fermionic shift gates in terms of extra quantum gates. For example, for single excitations, the U₀^{α} gate can be implemented as a two-qubit gate generated by a pauli string consisting of two σ^{z} operations.

According to some embodiments, simulations are performed without violating principles to prevent execution on real quantum hardware.

According to an embodiment, calculations are performed using an open-source python package developed by the research group called tequila (https://github.com/aspuru-guzik-group/tequila, the entirety of which is hereby incorporated by reference) but can also be implemented with other packages.

According to an embodiment, a basic example for gradient based optimization of ground and excited energies of a Hydrogen molecule is illustrated by presenting the implementation in Tequila. It is also noted that the framework is implemented for other fixed approaches like UpCCGSD and the implementation allows arbitrary combinations of fermionic excitation unitaries and general quantum gates.

In some embodiments, the operator is used to generate, according to a coupled cluster method, an eigenenergy value of a Hamiltonian modelling a quantum property, such as a ground state of a molecule or an excited state of a molecule, or an energy convergence value of an n-fold excitation for a molecule. For example, the operator is used to evaluate or optimize expectation values of a fermionic system. This can be done by evaluating a gradient of an expectation value using the operator or to construct an objective function explicitly dependent on the gradient expectation values which can itself be optimized using gradient based or non-gradient based methods.

According to an embodiment, the ground and excited states of a Hydrogen molecule in the minimal representation where there are two electrons in four spin-orbitals (STO-3G(2,4)) is illustrated using the directly differentiable operators by restricting the unitary to a single double excitation generator G_{(0,2),(1,3)} where the two electrons are transferred between the two spin-up orbitals (0 and 2) and spin-down orbitals (1 and 3).

According to an embodiment, another example for a Hydrogen molecule in 4 spatial orbitals (6-31G) where the difference between the gradient of the expectation value computed with various fermionic generators is shown for complex wavefunctions using the fermionic excitation generator G₀₂₁₃ which excites electron from configuration |0011 . . . [symbol] to |1100 . . . [symbol] where all the other orbitals can either be occupied (1) or unoccupied (0).

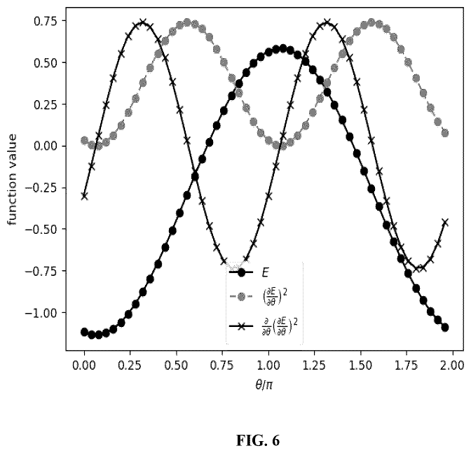

According to an embodiment, FIG. 6 illustrates the gradient of the energy expectation value for the Hydrogen molecule in 4 spatial orbitals with respect to a different fermionic generators.

According to an embodiment, the automatically differentiable framework can be used to replace adaptive approaches such as qubit-coupled-cluster or adapt-vqe. The difference lies at least between the way of screening and constructing operators. In these approaches the commutator between the Hamiltonian and the generator of potential excitations is used in the screening process to compute the gradient. In order to perform the actual optimization with gradient based methods on a quantum computer the commutator approach may at most only work for the gradient of the operator added last to the unitary circuit. With an automatically differentiable framework, screening as well as optimization can be treated in the same way. In some embodiments, this allows for more generalized adaptive growth procedures where the adaptive part is not restricted to be the trailing part of the quantum circuit.

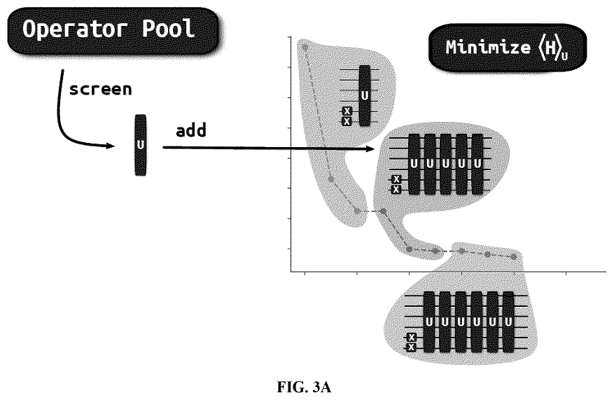

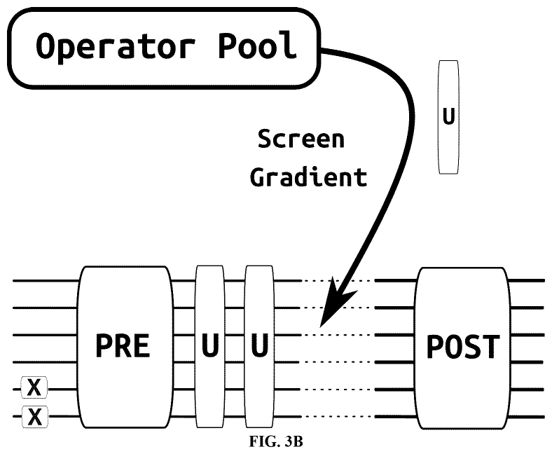

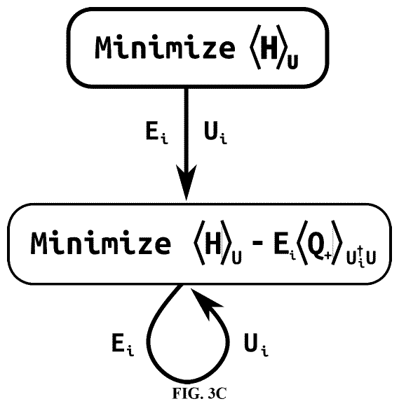

According to an embodiment, FIGS. 2 and 3A, 3B, and 3C illustrate a procedure for constructing adaptive circuits, combining adaptive and static parts and a method for sequentially solving for excited states of a chemical Hamiltonian.

According to an embodiment, initial demonstrations of combining adaptively growing unitaries (A) with static blocks of generalized singles (S) and double (D) excitations are illustrated for two chemical systems.

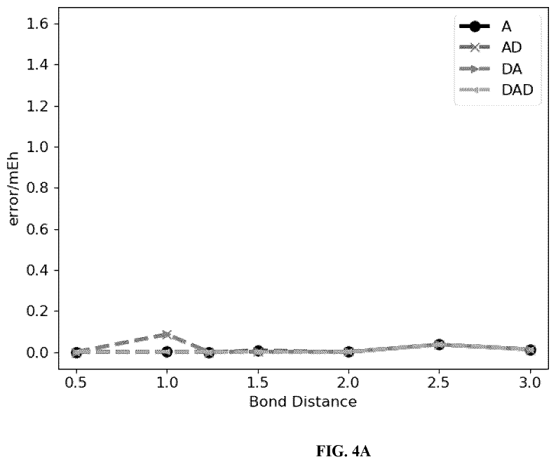

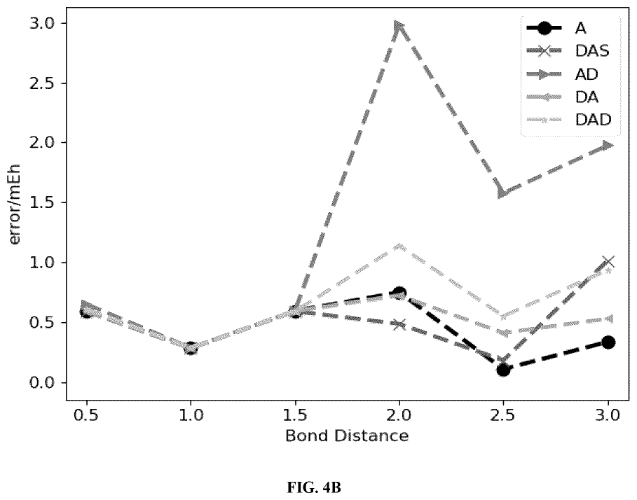

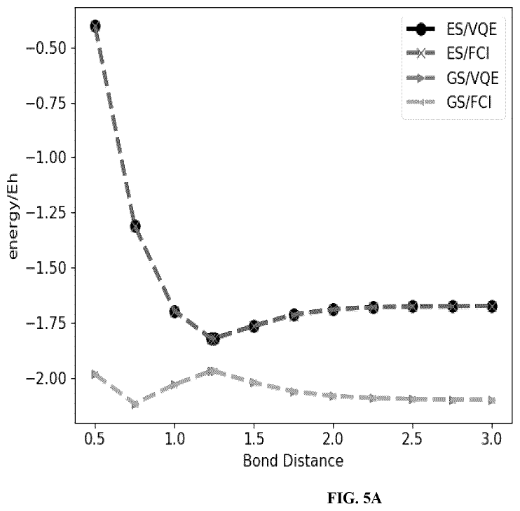

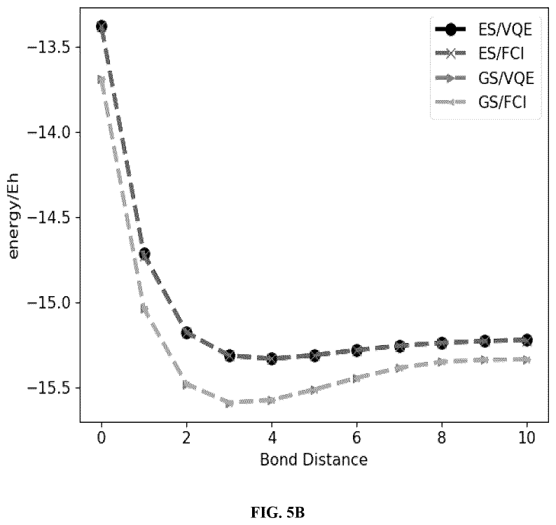

According to an embodiment, FIGS. 4A and 4B and 5A and 5B illustrate the results for two different systems H₄ in the minimal basis STO-3G (4 electrons in 8 spin orbitals) and BeH₂ in the minimal basis STO-3G (6 electrons in 14 spin orbitals) using different combinations of static (abbreviated as D and S) and adaptive (abbreviated as D) blocks in the quantum unitary.

According to a further embodiment, a modified adaptive ground-state algorithm to optimize excited states was used. According to an embodiment, a variational quantum algorithm for bound excited states may be achieved by projecting previously solved solutions. According to an embodiment, as the previous solution with the unitaries U is known, the variational preparation of the target excited state becomes equal to the minimization of function (A20) where [symbol] O [symbol] _{U} denotes the expectation value of the operator O with respect to the wave function prepared by unitary U and operator Q₊ denotes the projector on an all-zero state as per function (A21). The second term of function (A20) computes the square of the overlap between two wave functions, scaled by the energy of the previous state, to ensure orthogonality to all previous solutions.

$$E = {〈 U 〉}_{U ( θ )} - {\sum }_{i} {E}_{i} 〈 {Q}_{{+ 〉}_{{U}_{i}^{†} U ( θ )}} \qquad ( A20 )$$

$${Q}_{+} = \vert 00 .. 00 〉 〈 00 .. 00 \vert = {⊗}^{n} \frac{1}{2} ( 1 + {σ}_{z} ) \qquad ( A21 )$$

According to an embodiment, other than the Hamiltonian H, the Q₊ operator comprises a property in which all of its components naturally commute which allows for sampling of all terms within a single run. The additional measurements from Q₊ are negligible when compared to the Hamiltonian H.

According to an embodiment, the sequential strategy is combined with adaptive solvers by replacing the original objection function of the expectation value of the Hamiltonian with function (A20) and solving sequentially for low lying excited states.

According to an embodiment, the Ansatz is restricted from breaking particle number symmetry. This can allow for sequential solvers. According to an embodiment, the sequential optimization may become less practical if particle symmetry is broken as the entire Fock space may be considered.

According to an embodiment, using the Hartree-Fock configuration for ground-states starting from spin-adapted configurations for the excited-states where the dominant CIS contributions for the singlet were used as well for its counterpart for the triplet. According to an embodiment, the dominant contribution of the lowest configuration interaction singles solution is used as reference for the excited state calculation for BeH₂ and for H₄ the Hartree-Fock reference is used, illustrating different initialization strategies.

According to an embodiment, FIGS. 4 and 5 illustrate the results for ground and excited state energies for two different systems H₄ in the minimal basis STO-3G (4 electrons in 8 spin orbitals) and BeH₂ in the minimal basis STO-3G (6 electrons in 14 spin orbitals) using Adapt-VQE with automatic differentiation for screening and optimization.

According to an embodiment, one or more adaptive blocks and one or more static blocks are used in an overall circuit, wherein the one or more adaptive blocks are placed in any sequence in the overall circuit without incurring costs based on the position of the one or more adaptive blocks. For example, adaptive and static blocks can be combined with one or more adaptive blocks placed anywhere in the overall circuit without having extra screening costs (as well as actual optimization costs) influenced by the position of the adaptive block.

According to an embodiment, the operator is used to generate elementary building blocks of quantum circuits that approximate general objective functions defined by sets of expectation values of quantum chemical systems. Examples are approximations of ground and excited eigenstates of a quantum chemical Hamiltonian. Those prepared eigenstates can be used to measure properties of the molecule like the energy, the gradient with respect to parameters in the Hamiltonian, such as molecular coordinates, bond lengths and angles, dipole and transition dipole moments.

Various embodiments of the present invention have been described in detail. The present invention may be embodied in other specific forms without departing from the nature, spirit, or scope of the invention. The discussed embodiments are to be considered illustrative and not restrictive; the scope of the invention is to be indicated by the appended claims rather than the described details of the embodiments. Therefore, all changes which come with the meaning and range of equivalency of the claims are intended to be embraced therein.

What is claimed is:

1. A method performed by a classical computer for implementing, on a quantum computer, an operator, wherein:
the quantum computer having a plurality of qubits and configurable to implement a universal set of gates;
the classical computer including a processor, a non-transitory computer-readable medium, and computer program instructions stored in the non-transitory computer-readable medium, the computer program instructions being executable by the processor to perform the method, the method comprising:
generating and storing, in the non-transitory computer-readable medium, computer-readable data that, when executed on the quantum computer, causes a quantum circuit of the quantum computer to execute repeatedly to perform a sequence of operations that implements a unitary transformation for reducing the evaluation of a gradient to measurement of one or more expectation values.

2. The method of claim 1, wherein the unitary transformation is implemented by implementing:
a polynomial expansion
$${e}^{i θ \hat{G}} = {\sum }_{n = 0}^{L - 1} {a}_{n} ( θ ) {( i \hat{G} )}^{n}$$
of the unitary transformation, where G is the generator of the unitary transformation, θ is the amplitude for the gradient taken, aₙ(θ) are functions for evaluation, and L is the number of distinct eigenvalues present in G.

3. The method of claim 1, wherein the unitary transformation is implemented by implementing:
a generator decomposition to low-eigenvalue operators, where the generator decomposition is
$$\text{?} = {\sum }_{\text{?}}^{\text{?}} \text{?} ,$$
$$\text{?} \text{indicates text missing or illegible when filed}$$
where G is the generator, K is the number of terms, dₙ represents coefficients to be determined, and Oₙ represents operators with two or three distinct eigenvalues.

4. The method of claim 3, wherein the generator decomposition is based on a Cartan sub-algebra (CSA).

5. The method of claim 4, wherein the CSA is a commutative CSA decomposition
$$G = {\hat{V}}^{†} ( {\sum }_{n = 1}^{K} {c}_{n} {\hat{Z}}_{n} ) \hat{V} ,$$
where G is the generator, V is a unitary transformation, cₙ are coefficients, Zₙ are CSA elements, and K is the number of terms.

6. The method of claim 4, wherein the CSA is a non-commutative CSA decomposition
$$\hat{G} = {\sum }_{n = 1}^{{K}^{′}} {c}_{n} {\hat{V}}_{n}^{†} {\hat{Z}}_{n} {\hat{V}}_{n} ,$$
where G is the generator, Vₙ are unitary transformations, cₙ are coefficients, Zₙ are CSA elements, and K is the number of terms.

7. The method of claim 4, wherein the generator decomposition provides an implementation that reduces the evaluation of the gradient to evaluation of a linear combinations of expectation values that can be measured on the quantum computer.

8. The method of claim 1, wherein the operator is an n-fold fermionic excitation operator, the analytical gradients having fermionic shift operations, and the sequence of operations implements a unitary
$${e}^{- i \frac{θ}{2} G} = cos ( \frac{θ}{2} ) 1 - i sin ( \frac{θ}{2} ) G + ( 1 - cos ( \frac{θ}{2} ) ) {P}_{0} ,$$
wherein P₀ is the null space projector onto the eigenvectors of the n-fold excitation operator G_{pq}, wherein G_{pq}=i(Πₙaₚ_{ₙ}^{†}a_{q}_{ₙ}−h.c.), wherein aₚ_{ₙ}^{†} is a creation operator for the n-fold excitation of the orbital pₙ, and wherein a_{q}_{ₙ} is an annihilation operator for the n-fold excitation of the orbital qₙ; the method further comprising either:
calculating the analytical gradient of an expectation value
$$\frac{\partial {〈 H 〉}_{X U ( θ ) Y}}{\partial θ} = \frac{1}{4} {Σ}_{α ∈ \{ + , - \}} ( {〈 H 〉}_{X {U}_{+}^{α} Y} - {〈 H 〉}_{{XU}_{-}^{α} Y} )$$
by measuring only four expectation values, wherein
$${U}_{\pm }^{α} ( θ ) = {U}_{\pm } ( θ ) {U}_{0}^{α} = {e}^{- i \frac{1}{2} ( θ \pm \frac{π}{2} ) G} {e}^{- α \frac{i}{2} ( \pm \frac{π}{2} ) {P}_{0}}$$
are the fermionic shift gates, and wherein P₀ is the null space projector onto the eigenvectors of the n-fold excitation operator G; or
calculating the analytical gradient of an expectation value
$$\frac{\partial {〈 H 〉}_{X U ( θ ) Y}}{\partial θ} = \frac{1}{2} ( {〈 H 〉}_{X {U}_{+}^{α} Y} - {〈 H 〉}_{{XU}_{-}^{α} Y} )$$
by measuring only two expectation values for real wavefunctions, wherein α can be either + or −,
$${U}_{\pm }^{α} ( θ ) = {U}_{\pm } ( θ ) {U}_{0}^{α} = {e}^{- i \frac{1}{2} ( θ \pm \frac{π}{2} ) G} {e}^{- α \frac{i}{2} ( \pm \frac{π}{2} ) {P}_{0}}$$
are the fermionic shift gates, and wherein P₀ is the null space projector onto the eigenvectors of the n-fold excitation operator G.

9. The method of claim 8, wherein the generator G=(P₊+P₋) and is decomposed into a linear combination of two idempotent and directly differentiable operators P_{±}, wherein P₊ and P₋ are projectors onto the eigenfunctions of G with corresponding eigenvalues ±1.

10. The method of claim 8, wherein the generator G is decomposed into a linear combination of normal operators Oₙ with a low number of distinct eigenvalues
$$\hat{G} = {\sum }_{n = 1}^{K} {d}_{n} {\hat{O}}_{n} ,$$
where dₙ represent numerical coefficients from the field of real numbers and Oₙ, represent operators.

11. The method of claim 10, wherein for N-qubit generators, operators Oₙ are implemented using commutative CSA decomposition
$$\hat{G} = {\hat{V}}^{†} ( {\sum }_{n = 1}^{K} {c}_{n} {\hat{Z}}_{n} ) \hat{V} ,$$
where K is the number of terms, cₙ represent coefficients, \hat{Z}ₙ represents products of Pauli z operators, and \hat{V} is a unitary transformation
$$\hat{V} = {\prod }_{k} {e}^{i {τ}_{k} {\hat{P}}_{k}} ,$$
with real amplitudes τₖ, and Pauli operator products \hat{P}ₖ.

12. The method of claim 10, wherein for N-qubit generators, operators Oₙ are implemented using non-commutative CSA decomposition:
$$\hat{G} = {\sum }_{n = 1}^{{K}^{′}} {c}_{n} {\hat{V}}_{n}^{†} {\hat{Z}}_{n} {\hat{V}}_{n} ,$$
where K′ is the number of terms, \hat{V}ₙ represents unitary transformations defined in the same form as \hat{V}, cₙ represent coefficients, and \hat{Z}ₙ represent products of Pauli z operators.

13. The method of claim 10, wherein for fermionic operators, operators Oₙ are implemented using commutative CSA decomposition based on polynomial functions of the occupation number operators.

14. The method of claim 10, wherein the low number of distinct eigenvalues is two or three.

15. The method of claim 8, wherein the generator
$$G = \frac{1}{2} ( {G}_{+} + {G}_{-} )$$
and is decomposed into a linear combination of two self-inverse and directly differentiable operators G_{±}=G±P₀, wherein P₀ is a projector onto an eigenspace of G, wherein P₀ has an eigenvalue of zero.

16. The method of claim 8, wherein the generator G_{±}=G±P₀ is used as an approximation to the generator G.

17. The method of claim 8, wherein
$${P}_{\pm } = \frac{1}{2} ( {G}_{\pm } \pm 1 )$$
is used as an approximation to the generator G.

18. The method in claim 8, wherein P_{0;pq}=1−Πᵢ₌₁^{N}(Q₋(pᵢ))(Q₊(qᵢ))+(Q₊(pᵢ))(Q₋(qᵢ)) is the null space projector in the qubit perspective, wherein
$${Q}_{\pm } = \frac{1 + {σ}^{\pm }}{2} .$$

19. The method in claim 8, wherein P_{0;pq}=1−Nₚ_{₀}Ñ_{q}_{₀} . . . Nₚ_{ₙ}Ñ_{q}_{ₙ}−N_{q}_{₀}Ñₚ_{₀} . . . N_{q}_{ₙ}Ñₚ_{ₙ} is the null space projector in the fermionic perspective, wherein particle number operator N_{pq}=aₚ^{†}a_{q} and hole number operator Ñ_{pq}=1−N_{pq}=aₚa_{q}^{†}.

20. The method of claim 8, wherein the operator is used to generate elementary building blocks of quantum circuits that approximate general objective functions defined by sets of expectation values of quantum chemical systems.

21. A system comprising:
a classical computer, the classical computer comprising a processor, a non-transitory computer-readable medium, and computer program instructions stored in the non-transitory computer-readable medium;
a quantum computer comprising a plurality of qubits and configurable to implement a universal set of gates,
wherein the computer program instructions, when executed by the processor, perform a method for implementing, on the quantum computer, a n-fold fermionic excitation operator, the method comprising:
generating and storing, in the non-transitory computer-readable medium, computer-readable data that, when executed on the quantum computer, causes a quantum circuit of the quantum computer to execute repeatedly to perform a sequence of operations that implements a unitary transformation for reducing the evaluation of a gradient to measurement of one or more expectation values.

22. The system of claim 21, wherein the unitary transformation is implemented by implementing:
a polynomial expansion
$${e}^{i θ \hat{G}} = {\sum }_{n = 0}^{L - 1} {a}_{n} ( θ ) {( i \hat{G} )}^{n}$$
of the unitary transformation, where G is the generator of the unitary transformation, θ is the amplitude for the gradient taken, aₙ(θ) are functions for evaluation, and L is the number of distinct eigenvalues present in G.

23. The system of claim 21, wherein the unitary transformation is implemented by implementing:
a generator decomposition to low-eigenvalue operators, where the generator decomposition is
$$\hat{G} = {\sum }_{n = 1}^{K} {d}_{n} {\hat{O}}_{n} ,$$
where G is the generator, K is the number of terms, dₙ represents coefficients to be determined, and Oₙ represents operators with two or three distinct eigenvalues.

24. The system of claim 21, wherein the generator decomposition is based on a Cartan sub-algebra (CSA).

25. The system of claim 24, wherein the CSA is a commutative CSA decomposition
$$\hat{G} = {\hat{V}}^{†} ( {\sum }_{n = 1}^{K} {c}_{n} {\hat{Z}}_{n} ) \hat{V} ,$$
where G is the generator, V is a unitary transformation, cₙ are coefficients, Zₙ are CSA elements, and K is the number of terms.

26. The system of claim 24, wherein the CSA is a non-commutative CSA decomposition
$$\hat{G} = {\sum }_{k = 1}^{{K}^{′}} {c}_{n} {\hat{V}}_{n}^{†} {\hat{Z}}_{n} {V}_{n} .$$
where G is the generator, Vₙ are unitary transformations, cₙ are coefficients, Zₙ are CSA elements, and K is the number of terms.

27. The system of claim 24, wherein the generator decomposition provides an implementation that reduces the evaluation of the gradient to evaluation of a linear combinations of expectation values that can be measured on the quantum computer.

28. The system of claim 21, wherein the unitary is
$${e}^{- i \frac{θ}{2} G}$$
corresponding to the n-fold excitation operator G_{pq}, wherein G_{pq}=i(Πₙaₚ_{ₙ}^{†}a_{q}_{ₙ}−h.c.), wherein aₚ_{ₙ}^{†} is a creation operator for the n-fold excitation of the orbital pₙ, and a_{q}_{ₙ} is an annihilation operator for the n-fold excitation of the orbital qₙ; the method further comprising either:
calculating the analytical gradient of an expectation value
$$\frac{\partial {〈 H 〉}_{XU ( θ ) Y}}{\partial θ} = \frac{1}{4} {\sum }_{α ∈ \{ + , - \}} ( {〈 H 〉}_{{XU}_{+}^{α} Y} - {〈 H 〉}_{{XU}_{-}^{α} Y} )$$
by measuring only four expectation values, wherein
$${U}_{\pm }^{α} ( θ ) = {U}_{\pm } ( θ ) {U}_{0}^{α} = {e}^{- i \frac{1}{2} ( θ \pm \frac{π}{2} ) G} {e}^{- α \frac{i}{2} ( \pm \frac{π}{2} ) {P}_{0}}$$
are the fermionic shift gates, and wherein P₀ is the null space projector onto the eigenvectors of the n-fold excitation operator G; or
calculating the analytical gradient of an expectation value
$$\frac{\partial {〈 H 〉}_{XU ( θ ) Y}}{\partial θ} = \frac{1}{2} ( {〈 H 〉}_{{XU}_{+}^{α} Y} - {〈 H 〉}_{{XU}_{-}^{α} Y} )$$
by measuring only two expectation values for real wavefunctions, wherein α can be either + or −,
$${U}_{\pm }^{α} ( θ ) = {U}_{\pm } ( θ ) {U}_{0}^{α} = {e}^{- i \frac{1}{2} ( θ \pm \frac{π}{2} ) G} {e}^{- α \frac{i}{2} ( \pm \frac{π}{2} ) {P}_{0}}$$
are the fermionic shift gates, and wherein P₀ is the null space projector onto the eigenvectors of the n-fold excitation operator G.

29. The system of claim 28, wherein the operator is used to generate, according to a coupled cluster method, approximation to an eigenstate of a Hamiltonian modelling a quantum property.

30. The system of claim 28, the quantum property being a ground state of a molecule.

31. The system of claim 28, the quantum property being an excited state of a molecule.

32. The system of claim 28, wherein the operator is used to generate, according to a coupled cluster method, an energy convergence value of an n-fold excitation for a molecule.

33. The system of claim 28, wherein the operator is used to evaluate or optimize expectation values of a fermionic system.

34. The system of claim 28, wherein a second quantum circuit of the quantum computer executes instructions to evaluate a gradient of an expectation value using the operator.

35. The system of claim 28, wherein the quantum circuit implements gradient-based optimization using the operator.

36. The system of claim 28, wherein the generator G is decomposed into a linear combination of normal operators Oₙ with a low number of distinct eigenvalues
$$\hat{G} = {\sum }_{n = 1}^{K} {d}_{n} {\hat{O}}_{n} ,$$
where dₙ represent numerical coefficients from the field of real numbers and Oₙ, represent operators.

37. The system of claim 36, wherein for N-qubit generators, operators Oₙ are implemented using commutative CSA decomposition
$$\hat{G} = {\hat{V}}^{†} ( {\sum }_{n = 1}^{K} {c}_{n} {\hat{Z}}_{n} ) \hat{V} ,$$
where K is the number of terms, cₙ represent coefficients, \hat{Z}ₙ represents products of Pauli z operators, and \hat{V} is a unitary transformation
$$\hat{V} = {\prod }_{k} {e}^{i {τ}_{k} {\hat{P}}_{k}} ,$$
with real amplitudes τₖ, and Pauli operator products \hat{P}ₖ.

38. The system of claim 36, wherein for N-qubit generators, operators Oₙ are implemented using non-commutative CSA decomposition:
$$\hat{G} = {\sum }_{n = 1}^{{K}^{′}} {c}_{n} {\hat{V}}_{n}^{†} {\hat{Z}}_{n} {\hat{V}}_{n} ,$$
where K′ is the number of terms, \hat{V}ₙ represents unitary transformations defined in the same form as \hat{V}, cₙ represent coefficients, and \hat{Z}ₙ represent products of Pauli z operators.

39. The system of claim 36, wherein for fermionic operators, operators Oₙ are implemented using commutative CSA decomposition based on polynomial functions of the occupation number operators.

40. The system of claim 36, wherein the low number of distinct eigenvalues is two or three.

41. A computer product with non-transitory computer-readable media storing program instructions, the computer program instructions being executable on a quantum computer to:
cause a quantum circuit of the quantum computer to execute repeatedly to perform a sequence of operations that implements a unitary transformation for reducing the evaluation of a gradient to measurement of one or more expectation values.

42. The computer product of claim 41, wherein the unitary transformation is implemented by implementing:
a polynomial expansion
$${e}^{i θ \hat{G}} = {\sum }_{n = 0}^{L - 1} {a}_{n} ( θ ) {( i \hat{G} )}^{n}$$
of the unitary transformation, where G is the generator of the unitary transformation, θ is the amplitude for the gradient taken, aₙ(θ) are functions for evaluation, and L is the number of distinct eigenvalues present in G.

43. The computer product of claim 41, wherein the unitary transformation is implemented by implementing:
a generator decomposition to low-eigenvalue operators, where the generator decomposition is
$$\hat{G} = {\sum }_{k = 1}^{K} {d}_{n} {\hat{O}}_{n} ,$$
where G is the generator, K is the number of terms, dₙ represents coefficients to be determined, and Oₙ represents operators with two or three distinct eigenvalues.

44. The computer product of claim 43, wherein the generator decomposition is based on a Cartan sub-algebra (CSA).

45. The computer product of claim 44, wherein the CSA is a commutative CSA decomposition
$$\hat{G} = {\hat{V}}^{†} ( {\sum }_{n = 1}^{K} {c}_{n} {\hat{Z}}_{n} ) \hat{V} ,$$
where G is the generator, V is a unitary transformation, cₙ are coefficients, Zₙ are CSA elements, and K is the number of terms.

46. The computer product of claim 44, wherein the CSA is a non-commutative CSA decomposition
$$\hat{G} - {\sum }_{k = 1}^{{K}^{′}} {c}_{n} {\hat{V}}_{n}^{†} {\hat{Z}}_{n} {V}_{n}$$
where G is the generator, Vₙ are unitary transformations, cₙ are coefficients, Zₙ are CSA elements, and K is the number of terms.

47. The computer product of claim 44, wherein the generator decomposition provides an implementation that reduces the evaluation of the gradient to evaluation of a linear combinations of expectation values that can be measured on the quantum computer.

48. The computer product of claim 41, wherein the unitary corresponds to n-fold excitation generator
$${e}^{- i \frac{θ}{2} G}$$
corresponding to n-fold excitation operator G_{pq}=i(Πₙaₚ_{ₙ}^{†}a_{q}_{ₙ}−h.c.) wherein aₚ_{ₙ}^{†} is a creation operator for the n-fold excitation of the orbital pₙ and a_{q}_{ₙ} is an annihilation operator for the n-fold excitation of the orbital qₙ; the computer program instructions further being executable on the quantum computer to either:
calculate the analytical gradient of an expectation value
$$\frac{\partial {〈 H 〉}_{XU ( θ ) Y}}{\partial θ} = \frac{1}{4} {Σ}_{α ∈ \{ + , - \}} ( {〈 H 〉}_{{XU}_{+}^{α} Y} - {〈 H 〉}_{{XU}_{-}^{α} Y} )$$
by measuring only four expectation values, wherein
$${U}_{\pm }^{α} ( θ ) = {U}_{\pm } ( θ ) {U}_{0}^{α} = {e}^{- i \frac{1}{2} ( θ \pm \frac{π}{2} ) G} {e}^{- α \frac{i}{2} ( \pm \frac{π}{2} ) {P}_{0}}$$
are the fermionic shift gates, and wherein P₀ is the null space projector onto the eigenvectors of the n-fold excitation operator G; or
calculate the analytical gradient of an expectation value
$$\frac{\partial {〈 H 〉}_{XU ( θ ) Y}}{\partial θ} = \frac{1}{2} ( {〈 H 〉}_{{XU}_{+}^{α} Y} - {〈 H 〉}_{{XU}_{-}^{α} Y} )$$
by measuring only two expectation values for real wavefunctions, wherein α can be either + or −,
$${U}_{\pm }^{α} ( θ ) = {U}_{\pm } ( θ ) {U}_{0}^{α} = {e}^{- i \frac{1}{2} ( θ \pm \frac{π}{2} ) G} {e}^{- α \frac{i}{2} ( \pm \frac{π}{2} ) {P}_{0}}$$
are the fermionic shift gates, and wherein P₀ is the null space projector onto the eigenvectors of the n-fold excitation operator G.

49. The method of claim 8, the method further comprising:
generating and storing, in the non-transitory computer-readable medium, computer-readable data that, when executed on the quantum computer, causes the third quantum circuit of the quantum computer to:
execute a static block, the static block being optimizing the expected values at one or more static blocks of the third quantum circuit; and
execute an adaptive block, the adaptive block being performing the sequence of operations performed according to claim 20, iteratively, until a global convergence criterion is satisfied.

50. The computer product of claim 48, wherein one or more adaptive blocks and one or more static blocks are used in an overall circuit, wherein the one or more adaptive blocks are placed in any sequence in the overall circuit without incurring costs based on the position of the one or more adaptive blocks.

51. The method of claim 1, the sequence of operations implementing 2-qubit generators and calculating the analytical gradient of an expectation value by measuring 4 expectation values.

52. The method of claim 1, the sequence of operations implementing a transmon gate by implementing a transmon gate generator Ĝ=Ŵ^{†}(τ₀)[\sqrt{1+b²}\hat{x}₁+c\hat{x}₂]Ŵ(τ₀), where Ŵ(τ)=exp(iτŷ₁\hat{x}₂) and τ₀ is obtained using the conditions cos(2τ₀)=1/\sqrt{1+b²} and sin(2τ₀)=b/\sqrt{1+b²}.

53. The method of claim 52, wherein the transmon gate generator is implemented as
$$\hat{G} = {\hat{V}}^{†} ( {\sum }_{n = 1}^{K} {c}_{n} {\hat{Z}}_{n} ) \hat{V}$$
using \hat{V}=e^{iπ/4(ŷ}^{₁}^{+ŷ}^{₂}⁾Ŵ(τ₀) and the transmon gate generator is the sum of two operators, \sqrt{1+b²}\hat{V}^{†}\hat{z}₁\hat{V} and c\hat{V}^{†}\hat{z}₂\hat{V}.

54. The method of claim 53, wherein the gradient is evaluated using only four expectation values.

55. The method of claim 1, the sequence of operations implementing a match-gate by implementing a match-gate generator Ĝ_{match}=aA₁⁽¹⁾+bA₂⁽¹⁾+cA₃⁽¹⁾+dA₁⁽²⁾+eA₂⁽²⁾+fA₃⁽²⁾ where {a, b, c, d, e, f} are numerical constants, and
$$\{ {A}_{1}^{( 1 )} , {A}_{2}^{( 1 )} , {A}_{3}^{( 1 )} \} = \{ \frac{{\hat{z}}_{0} + {\hat{z}}_{1}}{2} , \frac{{\hat{x}}_{0} {\hat{x}}_{1} - {\hat{y}}_{0} {\hat{y}}_{1}}{2} , \frac{{\hat{x}}_{0} {\hat{y}}_{1} + {\hat{y}}_{0} {\hat{x}}_{1}}{2} \}$$
$$\{ {A}_{1}^{( 2 )} , {A}_{2}^{( 2 )} , {A}_{3}^{( 2 )} \} = \{ \frac{{\hat{z}}_{0} - {\hat{z}}_{1}}{2} , \frac{{\hat{x}}_{0} {\hat{x}}_{1} + {\hat{y}}_{0} {\hat{y}}_{1}}{2} , \frac{- {\hat{x}}_{0} {\hat{y}}_{1} + {\hat{y}}_{0} {\hat{x}}_{1}}{2} \}$$
are operators forming two [symbol] (2) algebras.

56. The method of claim 1, the sequence of operations implementing a match-gate by implementing a match-gate generator
$${\hat{G}}_{match} = {( {\hat{V}}_{2} {\hat{V}}_{1} )}^{†} ( \frac{{a}^{′} + {d}^{′}}{2} {\hat{z}}_{0} + \frac{{a}^{′} - {d}^{′}}{2} {\hat{z}}_{1} ) {\hat{V}}_{2} {\hat{V}}_{1}$$
wherein a′ and d′ are constants defined by the action of V₁ and V₂ transformations on the match-gate generator, wherein unitary transformations
$${\hat{V}}_{1} = {e}^{\frac{i}{2} a r c t a n ( c / b ) {A}_{1}^{( 1 )}} {e}^{\frac{i}{2} a r c t a n ( f / e ) {A}_{1}^{( 2 )}} ,$$
wherein unitary transformations
$${\hat{V}}_{2} = {e}^{\frac{i}{2} a r c t a n ( {b}^{′} / a ) {A}_{3}^{( 1 )}} {e}^{\frac{i}{2} a r c t a n ( {e}^{′} / d ) {A}_{3}^{( 2 )}} ,$$
wherein the combined action of V₁ and V₂ on the match-gate generator leads to
$${\hat{V}}_{2} {\hat{V}}_{1} \hat{G} {\hat{V}}_{1}^{†} {\hat{V}}_{2}^{†} = {a}^{′} {A}_{1}^{( 1 )} + {d}^{′} {A}_{1}^{( 2 )} .$$

57. The method of claim 1, the sequence of operations implementing a match-gate by implementing a match-gate generator that allows evaluation of its gradient with respect to the corresponding amplitude using four expectation values.

58. The method of claim 1, the sequence of operations implementing a fSim gate by implementing a fSim generator
$${\hat{G}}_{fSim} = \frac{θ}{2} ( {\hat{x}}_{1} {\hat{x}}_{2} + {\hat{y}}_{1} {\hat{y}}_{2} ) + \frac{ϕ}{4} ( 1 - {\hat{z}}_{1} ) ( 1 - {\hat{z}}_{2} ) .$$

59. The method of claim 58, wherein the fSim generator is implemented using a CSA decomposition
$${\hat{G}}_{fSim} = \frac{θ}{2} {\hat{V}}^{†} ( {\hat{z}}_{1} + {\hat{z}}_{2} ) \hat{V} + \frac{ϕ}{4} ( 1 - {\hat{z}}_{1} ) ( 1 - {\hat{z}}_{2} )$$
where
$$\hat{V} = {e}^{\frac{i π}{4} ( {\hat{y}}_{2} - {\hat{x}}_{1} )} {e}^{\frac{i π}{4} ( {\hat{y}}_{1} {\hat{z}}_{2} - {\hat{z}}_{1} {\hat{x}}_{2} )} .$$

60. The method of claim 59, further comprising evaluating the gradient with respect to the overall amplitude τ in the unitary transformation exp(iτĜ_{fSim}) using six expectation values.

61. The method of claim 59, further comprising evaluating the gradients of exp(iĜ_{fSim}(θ, ϕ)) with respect to θ and ϕ using four and two expectation values respectively.

62. The method of claim 1, the sequence of operations implementing 3-qubit generators using non-commutative CSA decomposition and evaluating a gradient by measuring only four expectation values.

63. The method of claim 62, wherein the 3-qubit generator is [symbol] .

64. The method of claim 62, wherein the 3-qubit generator is
$$G \approx \text{?} + \text{?} + \text{?} + \text{?} - \text{?} + \text{?} .$$
$$\text{?} \text{indicates text missing or illegible when filed}$$

65. The method of claim 1, the sequence of operations implementing S\hat{ }²-conserving fermionic generators.

66. The computer product of claim 41, the sequence of operations implementing 2-qubit generators and calculating the analytical gradient of an expectation value by measuring 4 expectation values.

67. The computer product of claim 41, the sequence of operations implementing a transmon gate by implementing a transmon gate generator [symbol] .

68. The computer product of claim 41, the sequence of operations implementing a match-gate by implementing a match-gate generator.

69. The computer product of claim 41, the sequence of operations implementing a fSim gate by implementing a fSim generator.

70. The computer product of claim 41, the sequence of operations implementing 3-qubit generators and calculating the analytical gradient of an expectation value by measuring 4 expectation values.

71. The computer product of claim 41, the sequence of operations implementing S\hat{ }²-conserving fermionic generators.

72. The system of claim 21, the sequence of operations implementing a transmon gate by implementing a transmon gate generator [symbol] .

73. The system of claim 21, the sequence of operations implementing a match-gate by implementing a match-gate generator.

74. The system of claim 21, the sequence of operations implementing a fSim gate by implementing a fSim generator.

75. The system of claim 21, the sequence of operations implementing 3-qubit generators and calculating the analytical gradient of an expectation value by measuring 4 expectation values.

76. The system of claim 21, the sequence of operations implementing S\hat{ }²-conserving fermionic generators.
